(19) United States
(12) Patent Application Publication
(10) Pub. No.: US 2026/0351198 A1
(43) Pub. Date: Nov. 5, 2026

(54) DISPLAY PANEL AND DISPLAY DEVICE

(71) Applicant: Xiamen Tianma Optoelectronics Co., Ltd., Xiamen (CN)

(72) Inventors: Jie Lin, Xiamen (CN); Zongcai Ding, Xiamen (CN)

(73) Assignee: Xiamen Tianma Optoelectronics Co., Ltd., Xiamen (CN)

(21) Appl. No.: 19/723,338

(22) Filed: Jun. 29, 2026

(30) Foreign Application Priority Data
Dec. 31, 2025 (CN) 202512058401.3

(51) Int. Cl. G09G 3/3266; G09G 3/32

(52) U.S. Cl. CPC G09G 3/3266; G09G 3/32; G09G 2300/0408; G09G 2300/0465; G09G 2310/0267; G09G 2310/0286; G09G 2310/08; G09G 2320/0223; G09G 2320/0233; G09G 2320/0247; G09G 2330/021

(57) ABSTRACT

Provided are a display panel and a display device. The display panel includes modulation transistors, modulation voltage signal lines, and modulation control signal lines. A first terminal of a modulation transistor is electrically connected to a first scan signal line, a modulation voltage signal line is electrically connected to a second terminal of the modulation transistor, and a modulation control signal line is electrically connected to a gate of the modulation transistor. A switching stage between a turn-on voltage of a first scan signal and a turn-off voltage of the first scan signal overlaps a valid pulse of a modulation control signal. In this manner, in the switching stage when the first scan signal switches from the turn-on voltage to the turn-off voltage, the modulation transistor is controlled to turn on, rapidly applying a modulation voltage to the first scan signal line through the modulation transistor.

### CROSS-REFERENCE TO RELATED APPLICATION

This application claims priority to Chinese Patent Application No. 202512058401.3, filed on Dec. 31, 2025, the disclosure of which is incorporated herein by reference in its entirety.

### TECHNICAL FIELD

The present disclosure relates to the field of display technologies and, in particular, to a display panel and a display device.

### BACKGROUND

With the continuous development of display technologies, consumers have raised higher expectations for the visual experience of display panels. High resolution, large size, and high refresh rates have become major development trends of current display panels.

However, as the display panels increase in size and resolution, non-uniform display brightness is more likely to occur, thereby adversely affecting the display effect.

### SUMMARY

The present disclosure provides a display panel and a display device.

According to an aspect of the present disclosure, a display panel is provided. The display panel includes multiple pixel driving circuits, multiple first scan signal lines, multiple shift register units, multiple modulation transistors, multiple modulation voltage signal lines, and multiple modulation control signal lines.

The multiple pixel driving circuits are arranged in an array.

The multiple first scan signal lines are electrically connected to the multiple pixel driving circuits and are configured to provide first scan signals to the multiple pixel driving circuits.

The multiple shift register units are cascaded, are correspondingly electrically connected to the multiple first scan signal lines, and are configured to output the first scan signals to the multiple first scan signal lines, and voltages of a first scan signal of the first scan signals include a turn-on voltage and a turn-off voltage.

A first terminal of a modulation transistor of the multiple modulation transistors is electrically connected to a first scan signal line of the multiple first scan signal lines.

A modulation voltage signal line of the multiple modulation voltage signal lines is electrically connected to a second terminal of the modulation transistor and is configured to provide a modulation voltage to the second terminal of the modulation transistor.

A modulation control signal line of the multiple modulation control signal lines is electrically connected to a gate of the modulation transistor and is configured to provide a modulation control signal to the gate of the modulation transistor, and the modulation control signal includes a valid pulse, and the valid pulse is configured to control the modulation transistor to turn on.

A switching stage between the turn-on voltage of the first scan signal and the turn-off voltage of the first scan signal overlaps the valid pulse of the modulation control signal.

According to another aspect of the present disclosure, a display device is provided. The display device includes a display panel. The display panel includes multiple pixel driving circuits, multiple first scan signal lines, multiple shift register units, multiple modulation transistors, multiple modulation voltage signal lines, and multiple modulation control signal lines.

The multiple pixel driving circuits are arranged in an array.

The multiple first scan signal lines are electrically connected to the multiple pixel driving circuits and are configured to provide first scan signals to the multiple pixel driving circuits.

The multiple shift register units are cascaded, are correspondingly electrically connected to the multiple first scan signal lines, and are configured to output the first scan signals to the multiple first scan signal lines, and voltages of a first scan signal of the first scan signals include a turn-on voltage and a turn-off voltage.

A first terminal of a modulation transistor of the multiple modulation transistors is electrically connected to a first scan signal line of the multiple first scan signal lines.

A modulation voltage signal line of the multiple modulation voltage signal lines is electrically connected to a second terminal of the modulation transistor and is configured to provide a modulation voltage to the second terminal of the modulation transistor.

A modulation control signal line of the multiple modulation control signal lines is electrically connected to a gate of the modulation transistor and is configured to provide a modulation control signal to the gate of the modulation transistor, and the modulation control signal includes a valid pulse, and the valid pulse is configured to control the modulation transistor to turn on.

A switching stage between the turn-on voltage of the first scan signal and the turn-off voltage of the first scan signal overlaps the valid pulse of the modulation control signal.

It is to be understood that the content described in this section is neither intended to identify key or critical features of the embodiments of the present disclosure nor intended to limit the scope of the present disclosure. Other features of the present disclosure become easily understood through the description provided below.

### BRIEF DESCRIPTION OF DRAWINGS

To illustrate technical solutions in the embodiments of the present disclosure more clearly, drawings used in the description of the embodiments are briefly described below. Apparently, the drawings described below illustrate some embodiments of the present disclosure, and those of ordinary skill in the art may obtain other drawings based on the drawings described below on the premise that no creative work is done.

FIG. 1 is a diagram illustrating the structure of a display panel according to an embodiment of the present disclosure.

FIG. 2 is a cross-sectional view taken along A-A′ of FIG. 1.

FIG. 3 is a diagram illustrating the structure of a pixel driving circuit according to an embodiment of the present disclosure.

FIG. 4 is a diagram of a first scan signal according to an embodiment of the present disclosure.

FIG. 5 is another diagram of a first scan signal according to an embodiment of the present disclosure.

FIG. 6 is another diagram of a first scan signal according to an embodiment of the present disclosure.

FIG. 7 is another diagram of a first scan signal according to an embodiment of the present disclosure.

FIG. 8 is another diagram of a first scan signal according to an embodiment of the present disclosure.

FIG. 9 is a diagram illustrating the structure of a shift register unit according to an embodiment of the present disclosure.

FIG. 10 is another diagram illustrating the structure of a display panel according to an embodiment of the present disclosure.

FIG. 11 is another diagram illustrating the structure of a display panel according to an embodiment of the present disclosure.

FIG. 12 is another diagram illustrating the structure of a display panel according to an embodiment of the present disclosure.

FIG. 13 is another diagram illustrating the structure of a display panel according to an embodiment of the present disclosure.

FIG. 14 is an operating timing diagram of a pixel driving circuit according to an embodiment of the present disclosure.

FIG. 15 is another diagram illustrating the structure of a display panel according to an embodiment of the present disclosure.

FIG. 16 is an operating timing diagram of a shift register unit according to an embodiment of the present disclosure.

FIG. 17 is another diagram illustrating the structure of a display panel according to an embodiment of the present disclosure.

FIG. 18 is another diagram illustrating the structure of a display panel according to an embodiment of the present disclosure.

FIG. 19 is another diagram illustrating the structure of a display panel according to an embodiment of the present disclosure.

FIG. 20 is another diagram illustrating the structure of a display panel according to an embodiment of the present disclosure.

FIG. 21 is another diagram illustrating the structure of a display panel according to an embodiment of the present disclosure.

FIG. 22 is another operating timing diagram of a pixel driving circuit according to an embodiment of the present disclosure.

FIG. 23 is another diagram illustrating the structure of a display panel according to an embodiment of the present disclosure.

FIG. 24 is another diagram illustrating the structure of a display panel according to an embodiment of the present disclosure.

FIG. 25 is another diagram illustrating the structure of a display panel according to an embodiment of the present disclosure.

FIG. 26 is another diagram illustrating the structure of a display panel according to an embodiment of the present disclosure.

FIG. 27 is another diagram illustrating the structure of a display panel according to an embodiment of the present disclosure.

FIG. 28 is another diagram illustrating the structure of a display panel according to an embodiment of the present disclosure.

FIG. 29 is another diagram illustrating the structure of a display panel according to an embodiment of the present disclosure.

FIG. 30 is another diagram illustrating the structure of a display panel according to an embodiment of the present disclosure.

FIG. 31 is a partial cross-sectional diagram of a display panel according to an embodiment of the present disclosure.

FIG. 32 is another diagram illustrating the structure of a display panel according to an embodiment of the present disclosure.

FIG. 33 is a partial cross-sectional diagram of a display panel according to an embodiment of the present disclosure.

FIG. 34 is another diagram illustrating the structure of a pixel driving circuit according to an embodiment of the present disclosure.

FIG. 35 is another operating timing diagram of a pixel driving circuit according to an embodiment of the present disclosure.

FIG. 36 is a diagram illustrating the structure of films of a pixel driving circuit in a display panel according to an embodiment of the present disclosure.

FIG. 37 is a diagram illustrating the structure of a first metal layer in the pixel driving circuit shown in FIG. 36.

FIG. 38 is a diagram illustrating the structure of a second metal layer in the pixel driving circuit shown in FIG. 36.

FIG. 39 is a diagram illustrating the structure of a third metal layer in the pixel driving circuit shown in FIG. 36.

FIG. 40 is a diagram illustrating the structure of a semiconductor layer in the pixel driving circuit shown in FIG. 36.

FIG. 41 is a diagram illustrating the structure of a fourth metal layer in the pixel driving circuit shown in FIG. 36.

FIG. 42 is a diagram illustrating the structure of a fifth metal layer in the pixel driving circuit shown in FIG. 36.

FIG. 43 is a diagram illustrating the structure of a sixth metal layer in the pixel driving circuit shown in FIG. 36.

FIG. 44 is a diagram illustrating the stacked structure of films in the pixel driving circuit shown in FIG. 36.

FIG. 45 is a diagram illustrating the structure of a display device according to an embodiment of the present disclosure.

### DETAILED DESCRIPTION

To make the technical solutions of the present disclosure better understood by those skilled in the art, the technical solutions in the embodiments of the present disclosure are described below clearly and completely in conjunction with the drawings in the embodiments of the present disclosure. Apparently, the embodiments described below are part, not all, of embodiments of the present disclosure. Based on the embodiments of the present disclosure, all other embodiments obtained by those of ordinary skill in the art are within the scope of the present disclosure on the premise that no creative work is done.

It is to be noted that terms such as “first” and “second” in the description, claims, and preceding drawings of the present disclosure are used for distinguishing between similar objects and are not necessarily used for describing a particular order or sequence. It is to be understood that data used in this manner are interchangeable where appropriate so that the embodiments of the present disclosure described herein can be implemented in an order not illustrated or described herein. In addition, the terms “including”, “having”, or any variations thereof are intended to encompass a non-exclusive inclusion. For example, a process, method, system, product, or device that includes a series of steps or units may include not only the expressly listed steps or units but also other steps or units that are not expressly listed or are inherent to such process, method, product, or device.

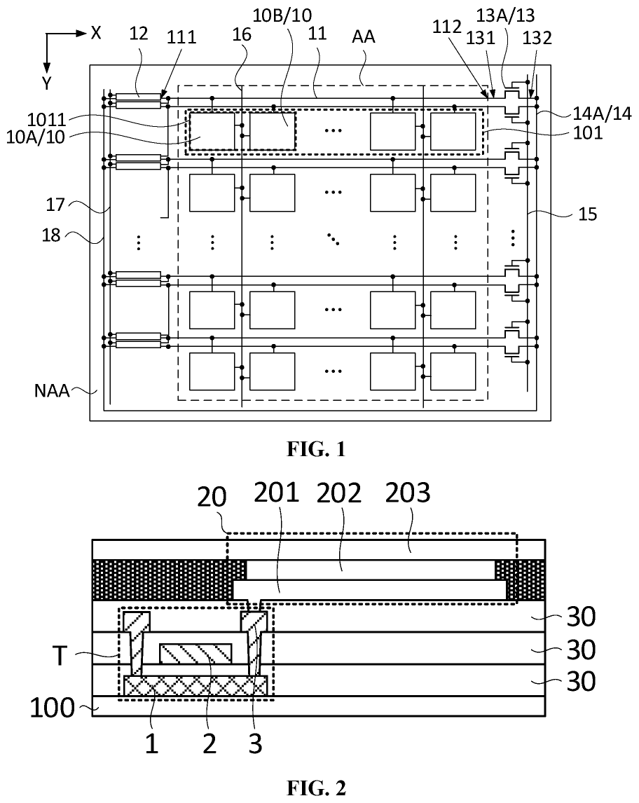

FIG. 1 is a diagram illustrating the structure of a display panel according to an embodiment of the present disclosure. FIG. 2 is a cross-sectional view taken along A-A′ of FIG. 1. As shown in FIGS. 1 and 2, the display panel provided in the embodiment of the present disclosure includes multiple pixel driving circuits 10, multiple first scan signal lines 11, multiple shift register units 12, multiple modulation transistors 13, multiple modulation voltage signal lines 14, and multiple modulation control signal lines 15.

The multiple pixel driving circuits 10 are arranged in an array.

The multiple first scan signal lines 11 are electrically connected to the multiple pixel driving circuits 10 and are configured to provide first scan signals scan1 to the multiple pixel driving circuits 10.

The multiple shift register units 12 are cascaded, are correspondingly electrically connected to the multiple first scan signal lines 11, and are configured to output the first scan signals scan1 to the multiple first scan signal lines 11, and voltages of a first scan signal scan1 include a turn-on voltage V11 and a turn-off voltage V12.

A first terminal 131 of a modulation transistor 13 is electrically connected to a first scan signal line 11.

A modulation voltage signal line 14 is electrically connected to a second terminal 132 of the modulation transistor 13 and is configured to provide a modulation voltage to the second terminal 132 of the modulation transistor 13.

A modulation control signal line 15 is electrically connected to a gate of the modulation transistor 13 and is configured to provide a modulation control signal K0 to the gate of the modulation transistor, and the modulation control signal K0 includes a valid pulse K01, and the valid pulse K01 is configured to control the modulation transistor 13 to turn on.

A switching stage T0 between the turn-on voltage V11 of the first scan signal scan1 and the turn-off voltage V12 of the first scan signal scan1 overlaps the valid pulse K01 of the modulation control signal K0.

In an embodiment, as shown in FIGS. 1 and 2, the multiple pixel driving circuits 10 are arranged in rows and columns and are formed within a display region AA of the display panel. Each pixel driving circuit 10 may be connected to at least one respective light-emitting element 20, thereby forming a sub-pixel of the display panel. The pixel driving circuit 10 is configured to, under the action of signals on signal lines (such as scan signal lines, data signal lines, and power voltage signal lines) of the display panel, transmit a light-emitting driving current to the at least one light-emitting element 20, thereby providing a driving current to the at least one light-emitting element 20 to drive the at least one light-emitting element 20 to emit light.

In some embodiments, a light-emitting element 20 may be an organic light-emitting diode (OLED), a micro light-emitting diode (MicroLED), or a mini light-emitting diode (Mini LED), which is not limited herein.

In one or more embodiments, as shown in FIG. 2, using the light-emitting element 20 being the organic light-emitting diode as an example for illustration, the light-emitting element 20 may include an anode 201, a light-emitting layer 202, and a cathode 203 that are stacked. When electrons and holes are injected into the light-emitting layer 202 from the cathode 203 and the anode 201, respectively, excitons are formed within the light-emitting layer 202 and excite light-emitting molecules, thereby causing the light-emitting layer 202 to emit visible light. The light-emitting layer 202 is configured to be made of different materials so that visible light in different colors can be emitted.

In some embodiments, the at least one light-emitting element 20 may include a red-color light-emitting element, a green-color light-emitting element, and a blue-color light-emitting element to display a colorful image. In some other embodiments, the at least one light-emitting element 20 may further include a white-color light-emitting element and others. This is not specifically limited in the embodiments of the present disclosure.

In some embodiments, as shown in FIG. 2, the pixel driving circuit 10 includes at least one transistor T. A transistor T may include an active layer 1, a gate 2, and source and drain electrodes 3 that are stacked on one side of a base substrate 100.

FIG. 3 is a diagram illustrating the structure of a pixel driving circuit according to an embodiment of the present disclosure. As shown in FIG. 3, for example, the at least one transistor T includes a driving transistor T3. In the pixel driving circuit 10, a light-emitting element 20 and the driving transistor T3 are connected in series between a first power voltage signal line 31 and a second power voltage signal line 32. The first power voltage signal line 31 is configured to transmit a first power voltage PVDD, and the second power voltage signal line 32 is configured to transmit a second power voltage PVEE, where the first power voltage PVDD is larger than the second power voltage PVEE.

The driving transistor T3 may be turned on according to the potential of a gate of the driving transistor T3, and a driving current formed by turning on the driving transistor T3 is configured to drive the light-emitting element 20 to emit light. The gate potential of the driving transistor T3 may determine the magnitude of the on-state current so that the brightness of the light-emitting element 20 can be adjusted by controlling the gate voltage of the driving transistor T3, thereby implementing grayscale control.

In some embodiments, as shown in FIG. 1, the multiple first scan signal lines 11 extend in parallel in the display panel, for example, being laid out along the row direction. Each first scan signal line 11 is connected to a respective row of pixel driving circuits 10, where each row of pixel driving circuits 10 may be connected to one or two independent first scan signal lines 11. FIG. 1 schematically illustrates an example in which each row of pixel driving circuits 10 is connected to two respective independent first scan signal lines 11, but this is not limited herein.

In some embodiments, as shown in FIG. 3, the pixel driving circuit 10 further includes a first switch transistor T1. The first switch transistor T1 is connected in series between the gate of the driving transistor T3 and a data signal line 16, and a gate of the first switch transistor T1 is electrically connected to the first scan signal line 11. Based on this, as shown in FIG. 1, gates of first switch transistors T1 in the same row of pixel driving circuits 10 are all connected to a first scan signal line 11 corresponding to the row of pixel driving circuits 10 so that at least part of the same row of pixel driving circuits 10 receives a unified first scan signal scan1.

In the pixel driving circuit 10, the first switch transistor T1 serves as a data writing switch, and the conduction state of the first switch transistor T1 is controlled by the first scan signal scan1 transmitted on the first scan signal line 11.

The first scan signal scan1 is a pulse signal generated by a shift register unit 12. As shown in FIG. 1, the multiple cascaded shift register units 12 form a gate driving circuit of the display panel, that is, a gate driver-on-array (GOA) circuit, which is arranged in a non-display region NAA along one or two sides of the bezel of the display panel and is configured to generate the first scan signals scan1 and output the first scan signals scan1 to the multiple first scan signal lines 11. Each first scan signal line 11 is connected to a respective shift register unit 12, thereby implementing row-by-row scanning control.

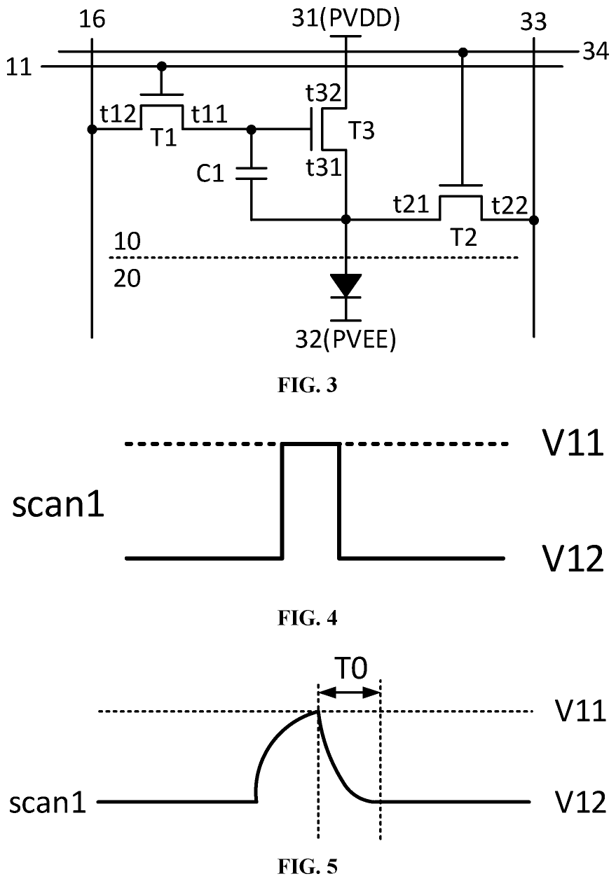

FIG. 4 is a diagram of a first scan signal according to an embodiment of the present disclosure. As shown in FIG. 4, the voltage of the first scan signal scan1 periodically switches between the turn-on voltage V11 (such as a high level) and the turn-off voltage V12 (such as a low level).

The turn-on voltage V11 refers to a voltage level of the first scan signal scan1 that is used to turn on a switch transistor (for example, the first switch transistor T1) in the pixel driving circuit 10.

As shown in FIG. 3, when the first scan signal scan1 is at the turn-on voltage V11, the first switch transistor T1 is turned on so that a data signal is allowed to be written from the data signal line 16 to the gate of the driving transistor T3, so as to control the conduction degree of the driving transistor T3 and determine the magnitude of the driving current flowing to the light-emitting element 20, thereby implementing grayscale display.

Furthermore, the turn-off voltage V12 refers to a voltage level of the first scan signal scan1 that is used to turn off a switch transistor (for example, the first switch transistor T1) in the pixel driving circuit 10.

As shown in FIG. 3, when the first scan signal scan1 is at the turn-off voltage V12, the first switch transistor T1 is turned off, so as to lock the written data signal at the gate of the driving transistor T3 and isolate the written data signal from interference caused by subsequent data signal variations on the data signal line 16.

In practical applications, when the first scan signal scan1 switches from the turn-on voltage V11 to the turn-off voltage V12, the first switch transistor T1 in the pixel driving circuit 10 needs to be turned off quickly and reliably. However, through research, the inventors have found that in a large-sized display panel (especially a display panel employing a single-sided driving architecture), the first scan signal line 11 usually extends across the entire display region AA along the row direction, and thereby has a relatively long physical length. The resistor of the first scan signal line 11 and parasitic capacitors between the first scan signal line 11 and other lines form a resistive-capacitive (RC) load. This RC load causes the first scan signal scan1 to experience significant signal delay and waveform distortion during transmission from a near end (facing the shift register unit 12) of the pixel driving circuit 10 to a far end (facing away from the shift register unit 12) of the pixel driving circuit 10.

FIG. 5 is another diagram of a first scan signal according to an embodiment of the present disclosure. As shown in FIG. 5, as the transmission distance of the first scan signal increases, the time required for a far-end first scan signal scan1 to drop from the turn-on voltage V11 to the turn-off voltage V12 gradually increases. The switching stage T0 between the turn-on voltage V11 and the turn-off voltage V12 exhibits a slowed falling edge slope and an increased falling time (that is, the duration of the switching stage T0), causing the turn-off operation of a far-end first switch transistor T1 to lag behind that of a near-end first switch transistor T1 in time. This would result in a non-uniform spatial distribution of the effective charging time of pixels, thereby causing non-uniform display. In an embodiment, under a row-by-row scanning driving solution, the theoretical data signal writing time (that is, a charging window) for each row of sub-pixels is fixed. Using the turn-on voltage V11 being at a high level and the turn-off voltage V12 being at a low level as an example, the theoretical data signal writing time for each row of sub-pixels starts at the rising edge of a first scan signal of the current row and ends at the rising edge of a first scan signal of the next row. However, the actual effective end moment of data signal writing for a row of sub-pixels should be determined by the moment when first switch transistors T1 of the row are completely and reliably turned off. Since the falling edge of the far-end first scan signal scan1 becomes slowed, the turn-off moment of the first switch transistor T1 corresponding to the far-end first scan signal scan1 occurs later than that of the near-end first switch transistor T1. Therefore, for the same row of sub-pixels, the actual effective charging time of far-end sub-pixels is shorter than that of near-end sub-pixels. This difference in charging times directly results in a lower charging ratio of the far-end sub-pixels compared with the near-end sub-pixels. When a static or dynamic image is displayed, this spatial difference in the charging ratios is converted into brightness or grayscale gradient, resulting in visually perceptible uniform brightness and thereby degrading display quality.

Moreover, when first switch transistors T1 of far-end pixel driving circuits 10 of the current row have not been completely turned off due to the delayed falling edge of the first scan signal scan1, the data signal line 16 may have already started writing a new data signal into the next row of pixel driving circuits 10. In this case, the data signal of the next row is written, through the first switch transistors T1 that have not been completely turned off, into gates of driving transistors T3 of the current row of pixel driving circuits 10, thereby interfering with the data signal already stored. This results in data crosstalk, causing the sub-pixel display to deviate from the target grayscale and thereby leading to grayscale distortion.

In addition, to ensure that first switch transistors T1 at the far-end positions can also have sufficient time to be completely turned off, thereby avoiding data crosstalk, a longer protection interval has to be reserved for scanning of each row in the timing design. As a result, the effective row time available for data signal writing is compressed, thereby constraining applications with high refresh rates or high resolution.

In view of the preceding technical problems, in the embodiment of the present disclosure, as shown in FIG. 1, the modulation transistors 13, the modulation voltage signal lines 14, and the modulation control signal lines 15 are provided. The first terminal 131 of the modulation transistor 13 is electrically connected to the first scan signal line 11, and the second terminal 132 of the modulation transistor 13 is electrically connected to the modulation voltage signal line 14. The modulation voltage signal line 14 is configured to provide the modulation voltage. The potential of the modulation voltage is set to a level capable of ensuring reliable turn-off of the first switch transistor T1. For example, the modulation voltage may be a voltage having the same potential as or a similar potential to the turn-off voltage V12.

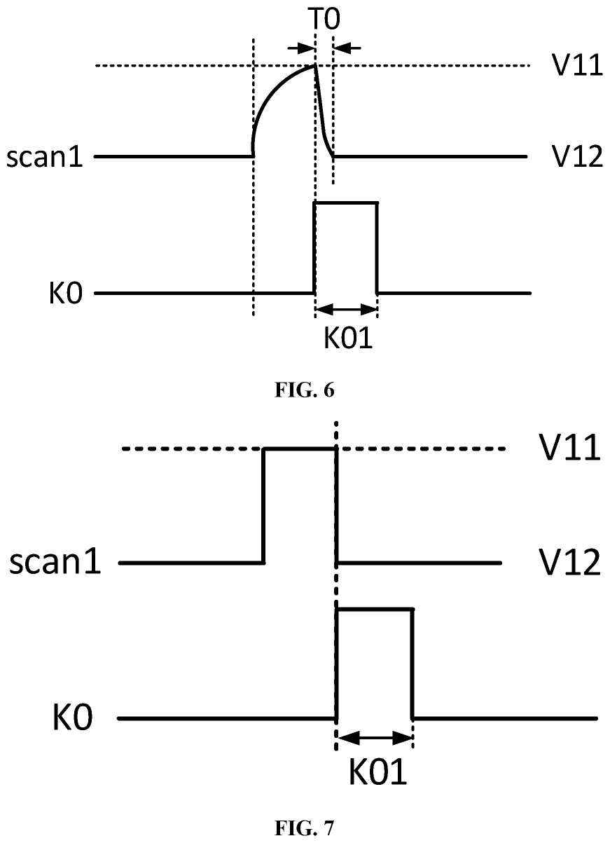

FIG. 6 is another diagram of a first scan signal according to an embodiment of the present disclosure. As shown in FIGS. 1 and 6, the gate of the modulation transistor 13 is electrically connected to the modulation control signal line 15 and is controlled by the modulation control signal K0 on the modulation control signal line 15. When the valid pulse K01 of the modulation control signal K0 is applied to the gate of the modulation transistor 13, the modulation transistor 13 is turned on (conductive).

In the embodiment of the present disclosure, the switching stage T0 between the turn-on voltage V11 of the first scan signal scan1 and the turn-off voltage V12 of the first scan signal scan1 overlaps the valid pulse K01 of the modulation control signal K0 in time. When the first scan signal scan1 needs to switch from the turn-on voltage V11 to the turn-off voltage V12, that is, in the switching stage T0, the modulation control signal K0 simultaneously provides a valid control pulse (the valid pulse K01) to drive the modulation transistor 13 into a conductive state. In this case, the modulation voltage on the modulation voltage signal line 14 is directly injected, through the turned-on modulation transistor 13 via the first terminal 131 of the modulation transistor 13, into the first scan signal line 11 with low impedance. This can accelerate the switching of the first scan signal scan1, significantly shorten the duration of the switching stage T0, and speed up the turn-off of the far-end first switch transistors T1, thereby ensuring that the switching stage T0 of the first scan signal scan1 at all positions along the entire first scan signal line 11 is fast and consistent. In this manner, the delay differences caused by the transmission distance can be effectively compensated.

In this manner, the potentials at all positions on the first scan signal scan1 are rapidly and synchronously pulled to the modulation voltage, and first switch transistors T1 at all positions (including the far-end ones) are turned off synchronously and quickly. This can eliminate the differences in effective charging times caused by variations in the turn-off moments of the first switch transistors T1, allowing the charging ratios of the near-end sub-pixels and the far-end sub-pixels within the same row to tend to be consistent and thereby suppressing non-uniform display brightness.

Moreover, the rapid turn-off of the first switch transistors T1 can shorten the time window during which the first switch transistors T1 are not completely turned off, lowering the possibility of data signal crosstalk during data signal switching and ensuring the accuracy of data signals written to sub-pixels.

In addition, the shortening of the switching stage T0 can allow the first switch transistors T1 to be turned off earlier, which, in the timing design, can facilitate the increase in the effective data signal writing time for each row, improve the charging ratio, and support higher resolution or higher refresh rates.

In conclusion, in the display panel provided in the embodiment of the present disclosure, the modulation transistor controlled by the modulation control signal with a specific timing is disposed on the first scan signal line, and in the switching stage when the first scan signal switches from the turn-on voltage to the turn-off voltage, the valid pulse of the modulation control signal is used to control the modulation transistor to turn on, rapidly applying the modulation voltage to the first scan signal line through the turned-on modulation transistor and thereby accelerating the switching of the first scan signal. As a result, the duration of the switching stage can be significantly shortened, ensuring that the duration of the switching stage of the first scan signal at all the positions along the entire first scan signal line is fast and consistent. This can effectively provide compensation for the delay differences caused by the transmission distance and thereby eliminate the differences in the effective charging times so that the charging ratios of the near-end sub-pixels and the far-end sub-pixels within the same row can tend to be consistent, thereby suppressing the non-uniform display brightness. Moreover, the possibility of data signal crosstalk in the switching stage can be lowered, thereby ensuring the accuracy of the data signals written into the sub-pixels. In addition, the timing design can facilitate the increase in the effective data signal writing time for each row, thereby improving the charging ratio and supporting the higher resolution or higher refresh rates.

FIG. 7 is another diagram of a first scan signal according to an embodiment of the present disclosure. As shown in FIG. 7, for example, the turn-on voltage V11 is higher than the turn-off voltage V12, and the modulation voltage is lower than the turn-on voltage V11.

In an embodiment, the first scan signal scan1 employs a high-level effective driving manner, that is, the turn-on voltage V11 is higher than the turn-off voltage V12. This configuration is applicable to a pixel driving circuit 10 in which an n-type transistor is used as the first switch transistor T1. Under this architecture, when the first scan signal scan1 is at the high-level turn-on voltage V11, a sufficiently high potential is applied to the gate of the first switch transistor T1 so that the channel of the first switch transistor T1 is turned on, thereby allowing the data signal to be written into the gate of the driving transistor T3 from the data signal line 16. Moreover, when the first scan signal scan1 switches to the low-level turn-off voltage V12, the gate-source voltage of the first switch transistor T1 is lower than the threshold voltage of the first switch transistor T1 so that the first switch transistor T1 is reliably turned off, thereby keeping the potential of the gate of the driving transistor T3 stable.

Furthermore, the modulation voltage is set to be lower than the turn-on voltage V11. For example, the modulation voltage is equal to or lower than the turn-off voltage V12, thereby ensuring that when the modulation transistor 13 is turned on, a valid pull-down potential can be provided to the first scan signal line 11.

As shown in FIG. 6, in the falling edge stage in which the first scan signal scan1 switches from the turn-on voltage V11 to the turn-off voltage V12 (that is, the switching stage T0), the modulation control signal K0 outputs the valid pulse K01, turning on the modulation transistor 13. Since the modulation voltage is lower than the turn-on voltage V11, the potential on the first scan signal line 11 can be rapidly pulled down, accelerating the drop of the potential of the first scan signal line 11, shortening the switching stage T0, and allowing the far-end first switch transistor T1 to be turned off synchronously with the near-end first switch transistor T1. As a result, display degradation caused by delayed turn-off of the far-end first switch transistor T1 can be avoided.

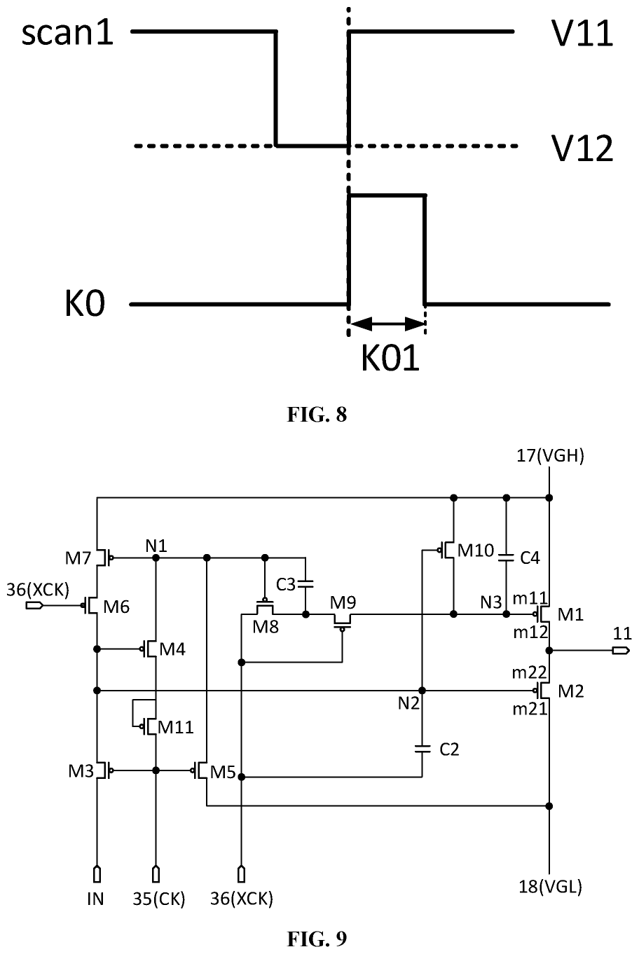

FIG. 8 is another diagram of a first scan signal according to an embodiment of the present disclosure. As shown in FIG. 8, for example, the turn-on voltage V11 is lower than the turn-off voltage V12, and the modulation voltage is higher than the turn-on voltage V11.

In an embodiment, the first scan signal scan1 employs a low-level effective driving logic, that is, the turn-on voltage V11 is lower than the turn-off voltage V12. This configuration is applicable to a pixel driving circuit 10 in which a p-type transistor is used as the first switch transistor T1. Under this architecture, when the first scan signal scan1 is at the low-level turn-on voltage V11, a sufficiently low potential is applied to the gate of the first switch transistor T1 so that the gate-source voltage of the first switch transistor T1 exceeds the threshold voltage of the first switch transistor T1, thereby turning on the channel of the first switch transistor T1 and allowing the data signal to be written into the gate of the driving transistor T3 from the data signal line 16. Moreover, when the first scan signal scan1 switches to the high-level turn-off voltage V12, the first switch transistor T1 is turned off due to the increased potential of the gate of the first switch transistor T1, thereby keeping the potential of the gate of the driving transistor T3 stable.

Accordingly, the modulation voltage is set to be higher than the turn-on voltage V11. For example, the modulation voltage is equal to or higher than the turn-off voltage V12. This ensures that when the modulation transistor 13 is turned on, a valid pull-up potential can be provided to the first scan signal line 11.

In an embodiment, in the rising edge stage in which the first scan signal scan1 switches from the turn-on voltage V11 (low level) to the turn-off voltage V12 (high level), the modulation control signal K0 outputs the valid pulse K01, turning on the modulation transistor 13. Since the modulation voltage is higher than the turn-on voltage V11, the first scan signal line 11 can be rapidly pulled up to the high level through the modulation transistor 13, accelerating the rise of the potential of the first scan signal scan1, shortening the switching stage T0, and allowing the far-end first switch transistor T1 to be turned off synchronously with the near-end first switch transistor T1. As a result, the display degradation caused by the delayed turn-off of the far-end first switch transistor T1 can be avoided.

FIG. 9 is a diagram illustrating the structure of a shift register unit according to an embodiment of the present disclosure. As shown in FIGS. 1 and 9, for example, the display panel provided in the embodiment of the present disclosure further includes a first voltage signal line 17 and a second voltage signal line 18. The shift register unit 12 includes a first transistor M1 and a second transistor M2. A first terminal m11 of the first transistor M1 is electrically connected to the first voltage signal line 17, a second terminal m12 of the first transistor M1 is electrically connected to the first scan signal line 11, and the first transistor M1 is configured to provide a first voltage VGH on the first voltage signal line 17 to the first scan signal line 11. A first terminal m21 of the second transistor M2 is electrically connected to the second voltage signal line 18, a second terminal m22 of the second transistor M2 is electrically connected to the first scan signal line 11, and the second transistor M2 is configured to provide a second voltage VGL on the second voltage signal line 18 to the first scan signal line 11. The first voltage VGH is higher than the second voltage VGL.

The multiple modulation voltage signal lines 14 include a first modulation voltage signal line 14A; the first modulation voltage signal line 14A is electrically connected to the first voltage signal line 17, and the modulation voltage is the same as the first voltage VGH.

Alternatively, the first modulation voltage signal line 14A is electrically connected to the second voltage signal line 18, and the modulation voltage is the same as the second voltage VGL.

In an embodiment, as shown in FIG. 9, the first transistor M1 and the second transistor M2 are output transistors of the shift register unit 12. The first terminal m11 of the first transistor M1 is an input terminal of the first transistor M1, and the second terminal m12 of the first transistor M1 is an output terminal of the first transistor M1. When the first transistor M1 is turned on, the first voltage VGH on the first voltage signal line 17 is transmitted to the first scan signal line 11. The first terminal m21 of the second transistor M2 is an input terminal of the second transistor M2, and the second terminal m22 of the second transistor M2 is an output terminal of the second transistor M2. When the second transistor M2 is turned on, the second voltage VGL on the second voltage signal line 18 is transmitted to the first scan signal line 11. The first transistor M1 and the second transistor M2 output the first voltage VGH and the second voltage VGL to the first scan signal line 11 in a time-division manner.

In the embodiment of the present disclosure, the first voltage VGH is a high-level power voltage, and the second voltage VGL is a low-level power voltage. The first voltage VGH and the second voltage VGL provided by the second voltage signal line 18 serve as two reference levels for scan driving, respectively, and their functions may be flexibly configured according to the type of the first switch transistor T1 employed and the driving logic.

In some embodiments, the first switch transistor T1 is the n-type transistor, in which case the first voltage VGH serves as the turn-on voltage V11, and the second voltage VGL serves as the turn-off voltage V12. In this mode, when the shift register unit 12 outputs the first voltage VGH to the first scan signal line 11, the first switch transistor T1 in the pixel driving circuit 10 is turned on because the potential of the gate of the first switch transistor T1 is higher than the potential of the source/drain of the first switch transistor T1, thereby allowing the data signal to be written. Moreover, when the shift register unit 12 outputs the second voltage VGL to the first scan signal line 11, the first switch transistor T1 is turned off, completing the writing of the data signal and keeping the potential of the gate of the driving transistor T3 stable.

Furthermore, as shown in FIGS. 1 and 9, the first modulation voltage signal line 14A is electrically connected to the second voltage signal line 18 so that the modulation voltage is equal to the second voltage VGL. In this case, in the switching stage T0 when the first scan signal scan1 switches from the turn-on voltage V11 (such as the first voltage VGH) to the turn-off voltage V12 (such as the second voltage VGL), the modulation transistor 13 is turned on to rapidly pull down the first scan signal line 11 to the second voltage VGL (that is, the turn-off voltage V12). This can accelerate the turn-off process of the first switch transistor T1, mitigate the problem of the slowed falling edge of the far-end first scan signal scan1 caused by RC delay, and ensure that the first switch transistor T1 is turned off rapidly and synchronously, thereby improving charging consistency and display uniformity.

In some embodiments, the first switch transistor T1 is a p-type transistor, in which case the first voltage VGH serves as the turn-off voltage V12, and the second voltage VGL serves as the turn-on voltage V11. In this mode, when the shift register unit 12 outputs the second voltage VGL to the first scan signal line 11, the first switch transistor T1 in the pixel driving circuit 10 is turned on, thereby allowing the data signal to be written. Moreover, when the shift register unit 12 outputs the first voltage VGH to the first scan signal line 11, the first switch transistor T1 is turned off, completing the writing of the data signal and keeping the potential of the gate of the driving transistor T3 stable.

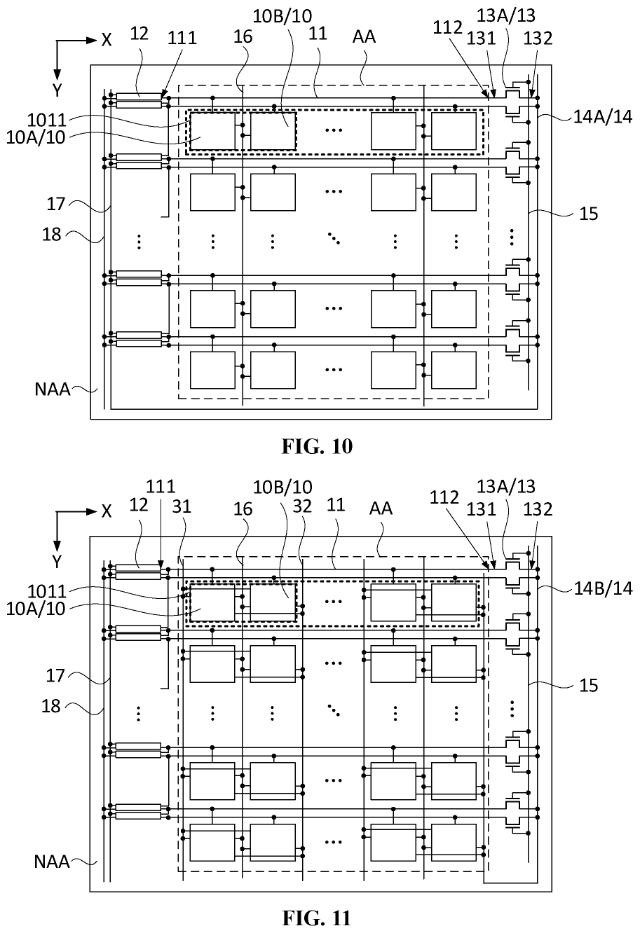

FIG. 10 is another diagram illustrating the structure of a display panel according to an embodiment of the present disclosure. As shown in FIGS. 9 and 10, for example, the first modulation voltage signal line 14A is electrically connected to the first voltage signal line 17 so that the modulation voltage is equal to the first voltage VGH. In this case, in the switching stage T0 when the first scan signal scan1 switches from the turn-on voltage V11 (such as the second voltage VGL) to the turn-off voltage V12 (such as the first voltage VGH), the modulation transistor 13 is turned on to rapidly pull up the first scan signal line 11 to the first voltage VGH (that is, the turn-off voltage V12). This can accelerate the turn-off process of the first switch transistor T1, mitigate the problem of the slowed falling edge of the far-end first scan signal scan1 caused by the RC delay, and ensure that the first switch transistor T1 is turned off rapidly and synchronously, thereby improving the charging consistency and the display uniformity.

The first modulation voltage signal line 14A directly reuses the first voltage signal line 17 or the second voltage signal line 18 that is used by the shift register unit 12, without additionally providing an independent power supply or signal line. This can effectively reduce wiring density and facilitate high pixel density and narrow-bezel design.

Moreover, this can allow the modulation voltage to be consistent with the turn-off voltage V12, so as to ensure that the first scan signal scan1 can be completely pulled down to the designed turn-off voltage V12. This can prevent incomplete turn-off of the first switch transistor T1 due to an insufficient pull-down potential, thereby avoiding grayscale distortion caused by data crosstalk.

It is to be noted that by configuring the first voltage VGH to be higher than the second voltage VGL, the shift register unit 12 can output the first scan signal scan1 with a well-defined logic state, thereby ensuring the accuracy and reliability of row-by-row scanning. The amplitude range of the first voltage VGH and the amplitude range of the second voltage VGL may be set according to actual requirements. For example, using the first switch transistor T1 being the n-type transistor as an example for illustration, the amplitude range of the first voltage VGH is from +10 V to +18 V, which is sufficient to completely turn on the first switch transistor T1; the amplitude range of the second voltage VGL is from −5 V to 0 V, which can effectively suppress the leakage current of the first switch transistor T1 and ensure the reliable turn-off of the first switch transistor T1. The voltage difference between the first voltage VGH and the second voltage VGL forms the effective swing of the first scan signal scan1, which can affect the conduction capability and timing stability of the first switch transistor T1. Those skilled in the art can set this voltage difference according to the actual requirements.

FIG. 11 is another diagram illustrating the structure of a display panel according to an embodiment of the present disclosure. As shown in FIGS. 3 and 11, for example, the display panel further includes multiple light-emitting elements 20 arranged in an array, and the multiple light-emitting elements 20 are electrically connected to the multiple pixel driving circuits 10. The display panel further includes multiple first power voltage signal lines 31 and multiple second power voltage signal lines 32. A pixel driving circuit 10 includes a driving transistor T3, and the driving transistor T3 and a light-emitting element 20 are connected in series between a first power voltage signal line 31 and a second power voltage signal line 32. A first power voltage PVDD transmitted by the first power voltage signal line 31 is higher than a second power voltage PVEE transmitted by the second power voltage signal line 32. The multiple modulation voltage signal lines 14 include a second modulation voltage signal line 14B. The second modulation voltage signal line 14B is the same signal line as the first power voltage signal line 31, and the modulation voltage is the same as the first power voltage PVDD. Alternatively, the second modulation voltage signal line 14B is the same signal line as the second power voltage signal line 32, and the modulation voltage is the same as the second power voltage PVEE.

The specific structure and function of the light-emitting element 20 can be referred to any of the preceding embodiments and are not repeated herein.

In this embodiment, the first power voltage signal lines 31 and the second power voltage signal lines 32 may be arranged within the display region AA. The driving transistor T3 of the pixel driving circuit 10 and the light-emitting element 20 are connected in series between the first power voltage signal line 31 and the second power voltage signal line 32, thereby forming a basic current-driving loop. The first power voltage PVDD transmitted by the first power voltage signal line 31 is higher than the second power voltage PVEE transmitted by the second power voltage signal line 32, so as to ensure that the light-emitting element 20 (such as a light-emitting diode) emits normally under a forward bias.

In some embodiments, as shown in FIG. 11, the second modulation voltage signal line 14B is connected to the second power voltage signal line 32 to form the same physical signal line so that the modulation voltage is equal to the second power voltage PVEE. This configuration is applicable to the pixel driving circuit 10 in which the first switch transistor T1 is the n-type transistor. In such an architecture, the turn-on voltage V11 is higher than the turn-off voltage V12, and the second power voltage PVEE may be the same as or similar to the turn-off voltage V12. During the operating process, in the falling edge stage in which the first scan signal scan1 switches from the turn-on voltage V11 to the turn-off voltage V12 (that is, the switching stage T0), the modulation control signal line 15 provides the valid pulse K01 to the gate of the modulation transistor 13 so that the modulation transistor 13 is turned on. Due to the shared use of the second modulation voltage signal line 14B and the second power voltage signal line 32, the second terminal 132 of the modulation transistor 13 is clamped at the second power voltage PVEE. Therefore, the first scan signal line 11 is rapidly discharged to the second power voltage PVEE (that is, is equivalent to the turn-off voltage V12) through the turned-on modulation transistor 13, forming a pull-down path with low impedance. This can accelerate the turn-off process of the first switch transistor T1, mitigate the problem of the slowed falling edge of the far-end first scan signal scan1 caused by the RC delay, and ensure that the first switch transistor T1 is turned off rapidly and synchronously, thereby improving the charging consistency and the display uniformity.

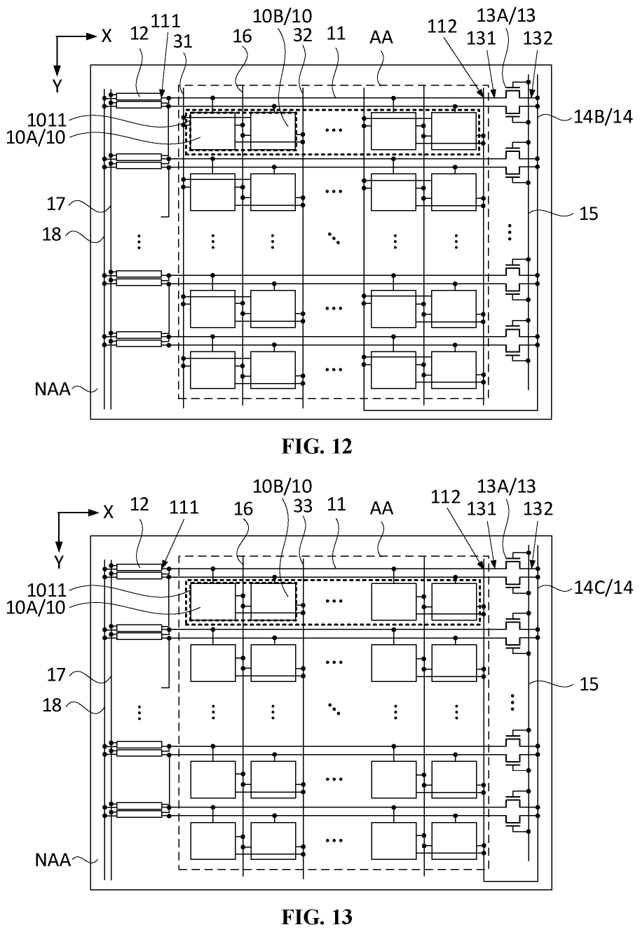

FIG. 12 is another diagram illustrating the structure of a display panel according to an embodiment of the present disclosure. As shown in FIG. 12, for example, the second modulation voltage signal line 14B is connected to the first power voltage signal line 31 to form the same physical signal line so that the modulation voltage is equal to the first power voltage PVDD. This configuration is applicable to the pixel driving circuit 10 in which the first switch transistor T1 is the p-type transistor. In such an architecture, the turn-on voltage V11 is lower than the turn-off voltage V12. During the operating process, in the falling edge stage in which the first scan signal scan1 switches from the turn-on voltage V11 to the turn-off voltage V12 (that is, the switching stage T0), the modulation control signal line 15 provides the valid pulse K01 to the gate of the modulation transistor 13 so that the modulation transistor 13 is turned on. Due to the shared use of the second modulation voltage signal line 14B and the first power voltage signal line 31, the second terminal 132 of the modulation transistor 13 is set to the first power voltage PVDD. The first scan signal line 11 is rapidly charged to the first power voltage PVDD (that is, is equivalent to the turn-off voltage V12) through the turned-on modulation transistor 13, forming a pull-up path with low impedance. This can accelerate the turn-off process of the first switch transistor T1, mitigate the problem of the slowed falling edge of the far-end first scan signal scan1 caused by the RC delay, and ensure that the first switch transistor T1 is turned off rapidly and synchronously, thereby improving the charging consistency and the display uniformity.

The second modulation voltage signal line 14B directly reuses the first power voltage signal line 31 or the second power voltage signal line 32 that is used by the pixel driving circuit 10, without additionally providing an independent power supply or signal line. This can effectively reduce the wiring density and facilitate the high pixel density and the narrow-bezel design.

FIG. 13 is another diagram illustrating the structure of a display panel according to an embodiment of the present disclosure. As shown in FIGS. 3 and 13, for example, the display panel further includes multiple light-emitting elements 20 arranged in an array, and the multiple light-emitting elements 20 are electrically connected to the multiple pixel driving circuits 10. A pixel driving circuit 10 includes a driving transistor T3, a first switch transistor T1, and a second switch transistor T2, and the driving transistor T3 and a light-emitting element 20 are connected in series between a first power voltage signal line 31 and a second power voltage signal line 32. A gate of the driving transistor T3 is electrically connected to a first terminal t11 of the first switch transistor T1, a second terminal t12 of the first switch transistor T1 is electrically connected to a data signal line 16, and a gate of the first switch transistor T1 is electrically connected to the first scan signal line 11. A first terminal t21 of the second switch transistor T2 is electrically connected to a first terminal t31 of the driving transistor T3, a second terminal t22 of the second switch transistor T2 is electrically connected to a reference voltage signal line 33, and a gate of the second switch transistor T2 is electrically connected to a second scan signal line 34. The multiple modulation voltage signal lines 14 include multiple third modulation voltage signal lines 14C, and a third modulation voltage signal line 14C is the same signal line as the reference voltage signal line 33, to provide the modulation voltage to the modulation transistor 13 via the reference voltage signal line 33.

The specific structures and functions of the light-emitting element 20, the driving transistor T3, the first power voltage signal line 31, and the second power voltage signal line 32 can be referred to any of the preceding embodiments and are not repeated herein.

In this embodiment, as shown in FIG. 3, the first switch transistor T1 is connected in series between the gate of the driving transistor T3 and the data signal line 16, and the gate of the first switch transistor T1 is connected to the first scan signal line 11 so that under the control of the turn-on voltage V11 of the first scan signal scan1, the data signal on the data signal line 16 can be written into the gate of the driving transistor T3.

The second switch transistor T2 is connected in series between the first terminal t31 of the driving transistor T3 and the reference voltage signal line 33, and the gate of the second switch transistor T2 is connected to the second scan signal line 34 so that under the control of a second scan signal scan2 on the second scan signal line 34, a reference voltage on the reference voltage signal line 33 can be written into the first terminal t31 of the driving transistor T3, thereby fulfilling a compensation function of the threshold voltage (Vth) of the driving transistor T3.

In some embodiments, as shown in FIG. 3, the first terminal t31 of the driving transistor T3 is one terminal of the driving transistor T3 that is connected to the light-emitting element 20, and a second terminal t32 of the driving transistor T3 is connected to the first power voltage signal line 31.

In some embodiments, as shown in FIG. 3, the pixel driving circuit 10 further includes a first capacitor C1, which is connected in series between the gate of the driving transistor T3 and the first terminal t31 of the driving transistor T3.

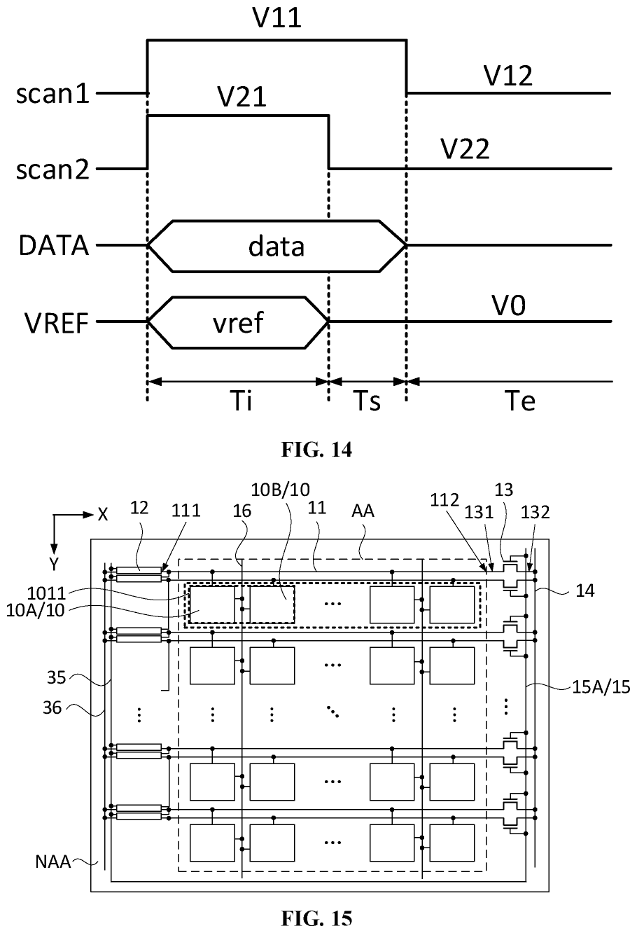

FIG. 14 is an operating timing diagram of a pixel driving circuit according to an embodiment of the present disclosure. As shown in FIGS. 3 and 14, for example, the operating cycle of the pixel driving circuit 10 may include an initialization stage Ti, a sensing stage Ts, and a light-emitting stage Te.

In the initialization stage Ti, the first scan signal scan1 provided by the first scan signal line 11 is maintained at the turn-on voltage V11, and the first switch transistor T1 is turned on in response to the turn-on voltage V11, so as to apply the data voltage (data) of the data signal DATA on the data signal line 16 to the gate of the driving transistor T3. Moreover, the second scan signal scan2 provided by the second scan signal line 34 is maintained at a turn-on voltage V21, and the second switch transistor T2 is turned on in response to the turn-on voltage V21, so as to apply the reference voltage vref of a reference voltage signal VREF on the reference voltage signal line 33 to the first terminal t31 of the driving transistor T3.

In the sensing stage Ts, the first scan signal scan1 provided by the first scan signal line 11 is maintained at the turn-on voltage V11, and the first switch transistor T1 remains turned on in response to the turn-on voltage V11. Accordingly, the gate voltage Vg of the driving transistor T3 is maintained at the data voltage (data). The second scan signal scan2 provided by the second scan signal line 34 is maintained at a turn-off voltage V22 so that the second switch transistor T2 is turned off. A current corresponding to the gate-source voltage Vgs of the driving transistor T3 that is set in the initialization stage Ti flows through the driving transistor T3. Therefore, the source voltage Vs of the driving transistor T3 rises toward the data voltage (data) applied to the gate of the driving transistor T3, and the gate-source voltage Vgs of the driving transistor T3 is configured to satisfy a desired gray level.

The light-emitting stage Te may be a period during which the light-emitting element 20 emits light based on a drain-source current of the driving transistor T3. In the light-emitting stage Te, the first scan signal scan1 provided by the first scan signal line 11 is maintained at the turn-off voltage V12 so that the first switch transistor T1 is turned off. The second scan signal scan2 provided by the second scan signal line 34 is maintained at the turn-off voltage V22 so that the second switch transistor T2 is turned off.

The gate voltage Vg of the driving transistor T3 and the source voltage Vs of the driving transistor T3 increase based on the drain-source current of the driving transistor T3, while the gate-source voltage Vgs of the driving transistor T3 that is set in the sensing stage Ts is maintained until the source voltage Vs reaches the operating point voltage of the light-emitting element 20. When the source voltage Vs reaches the operating point voltage of the light-emitting element 20, a driving current corresponding to the configured gate-source voltage Vgs of the driving transistor T3 flows through the light-emitting element 20, thereby driving the light-emitting element 20 to emit light and achieve the desired gray level.

The display panel provided in the embodiment of the present disclosure may be a self-luminous display panel, and the pixel driving circuit 10 may include a 3T1C circuit, a 7T1C circuit, an 8T1C circuit, or an 8T2C circuit. The 3T1C circuit indicates that the pixel driving circuit 10 includes three transistors and one capacitor; the 7T1C circuit indicates that the pixel driving circuit 10 includes seven transistors and one capacitor; the 8T1C circuit indicates that the pixel driving circuit 10 includes eight transistors and one capacitor; and the 8T2C circuit indicates that the pixel driving circuit 10 includes eight transistors and two capacitors. The 3T1C circuit is used as an example for illustration in FIG. 3, which is not limited herein.

Furthermore, as shown in FIG. 13, the third modulation voltage signal line 14C is connected to the reference voltage signal line 33 to form the same physical signal line so that the required modulation voltage is provided to the modulation transistor 13 via the reference voltage signal line 33. The third modulation voltage signal line 14C directly reuses the reference voltage signal line 33 used by the pixel driving circuit 10, without additionally providing an independent power supply or signal line. This can effectively reduce the wiring density and facilitate the high pixel density and the narrow-bezel design.

In one or more embodiments, as shown in FIGS. 3 and 14, the pixel driving circuit 10 has the light-emitting stage Te in which the first switch transistor T1 and the second switch transistor T2 are turned off. In the conduction stage of the second switch transistor T2, the reference voltage vref is transmitted on the reference voltage signal line 33. In the light-emitting stage Te, the modulation voltage V0 is transmitted on the reference voltage signal line 33. The reference voltage vref is different from the modulation voltage V0.

The operating cycle of the pixel driving circuit 10 can be referred to any of the preceding embodiments and is not repeated herein.

In this embodiment, the operating cycle of the pixel driving circuit 10 includes the light-emitting stage Te. In the light-emitting stage Te, the first switch transistor T1 and the second switch transistor T2 are in an off state, and the driving transistor T3 controls the current flowing through the light-emitting element 20 based on the data voltage stored at the gate of the driving transistor T3, thereby stably emitting light.

The reference voltage signal VREF transmitted on the reference voltage signal line 33 is dynamically switched in different operating stages.

In an embodiment, in the conduction stage of the second switch transistor T2 (for example, the initialization stage Ti), the voltage of the reference voltage signal VREF transmitted on the reference voltage signal line 33 is the reference voltage vref, which is used to provide a reference potential to internal nodes of the sub-pixels (such as the first terminal t31 of the driving transistor T3), so as to support operations performed on the threshold voltage Vth of the driving transistor T3, such as compensation, initialization, or pre-charging.

In the light-emitting stage Te, the voltage of the reference voltage signal VREF transmitted on the reference voltage signal line 33 is switched to the modulation voltage V0.

In an embodiment, after entering the light-emitting stage Te, the second switch transistor T2 is already turned off, and there is no direct electrical connection between the reference voltage signal line 33 and the internal nodes of the pixel driving circuit 10. In this case, the reference voltage signal line 33 can be reconfigured to output the modulation voltage V0. In this case, the modulation transistor 13 is connected to the reference voltage signal line 33. In the switching stage T0 between the turn-on voltage V11 of the first scan signal scan1 and the turn-off voltage V12 of the first scan signal scan1 (the switching stage T0 has already entered the light-emitting stage Te), the modulation transistor 13 can use the reference voltage signal line 33 to output the modulation voltage V0 to actively regulate the first scan signal line 11.

In some embodiments, the modulation voltage V0 is different from the reference voltage vref. For example, in the conduction stage of the second switch transistor T2 (such as the initialization stage Ti), the reference voltage vref is an intermediate voltage (for example, +2 V) used for precise compensation control; in the light-emitting stage Te, the modulation voltage V0 is close to or equal to the turn-off voltage V12 of the first scan signal scan1, so as to ensure an efficient turn-off capability. By switching the voltage of the reference voltage signal VREF on the reference voltage signal line 33 to the modulation voltage V0 in the light-emitting stage Te, a modulation voltage that satisfies the turn-off requirements can be provided to the modulation transistor 13 without adding additional wiring.

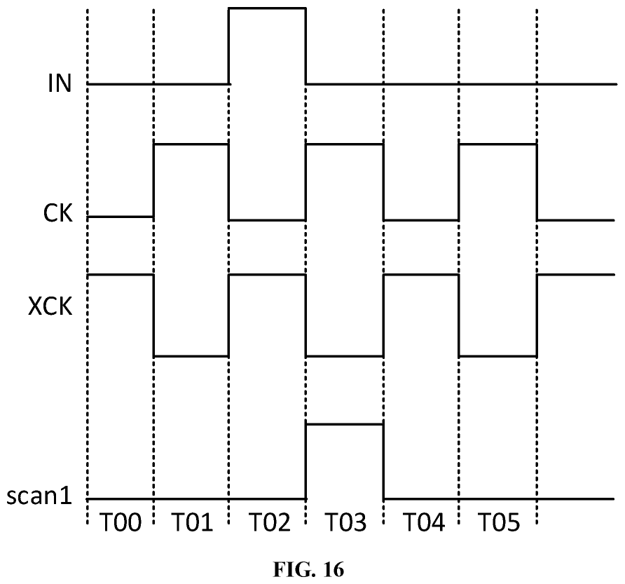

FIG. 15 is another diagram illustrating the structure of a display panel according to an embodiment of the present disclosure. FIG. 16 is an operating timing diagram of a shift register unit according to an embodiment of the present disclosure. As shown in FIGS. 8, 15, and 16, for example, the display pane further includes a first clock signal line 35 and a second clock signal line 36. The first clock signal line 35 is electrically connected to the multiple shift register units 12 and is configured to provide a first clock signal CK to the multiple shift register units 12. The second clock signal line 36 is electrically connected to the multiple shift register units 12 and is configured to provide a second clock signal XCK to the multiple shift register units 12. The first clock signal CK and the second clock signal XCK are inverted with respect to each other. The multiple modulation control signal lines 15 include a first modulation control signal line 15A. The first modulation control signal line 15A is electrically connected to the first clock signal line 35, and the modulation control signal may be the same as the first clock signal CK. Alternatively, the first modulation control signal line 15A is electrically connected to the second clock signal line 36, and the modulation control signal may be the same as the second clock signal XCK.

As shown in FIGS. 9, 15, and 16, the first clock signal CK provided by the first clock signal line 35 and the second clock signal XCK provided by the second clock signal line 36 are inverted with respect to each other. That is, when the first clock signal CK is at a high level, the second clock signal XCK is at a low level, and vice versa. This complementary clock pair serves as timing control signals for the stage-by-stage shift driving of the shift register units 12.

In one or more embodiments, as shown in FIG. 9, the shift register unit 12 includes a first transistor M1, a second transistor M2, a third transistor M3, a fourth transistor M4, a fifth transistor M5, a sixth transistor M6, a seventh transistor M7, an eighth transistor M8, a ninth transistor M9, a tenth transistor M10, an eleventh transistor M11, a second capacitor C2, a third capacitor C3, and a fourth capacitor C4.

A gate of the third transistor M3 is connected to the first clock signal line 35, and a first electrode of the third transistor M3 is connected to an input terminal IN.

A gate of the fourth transistor M4 is connected to a second electrode of the third transistor M3, and a second electrode of the fourth transistor M4 is connected to a first node N1.

A gate of the fifth transistor M5 is connected to the first clock signal line 35, a first electrode of the fifth transistor M5 is connected to the second voltage signal line 18, and a second electrode of the fifth transistor M5 is connected to the first node N1.

A gate of the sixth transistor M6 is connected to the second clock signal line 36, and a first electrode of the sixth transistor M6 is connected to the gate of the fourth transistor M4.

A gate of the seventh transistor M7 is connected to the first node N1, a first electrode of the seventh transistor M7 is connected to the first voltage signal line 17, and a second electrode of the seventh transistor M7 is connected to a second electrode of the sixth transistor M6.

A gate of the eight transistor M8 is connected to the first node N1, a first electrode of the eight transistor M8 is connected to the second clock signal line 36, and a second electrode of the eight transistor M8 is connected to a first electrode of the ninth transistor M9.

A gate of the ninth transistor M9 is connected to the second clock signal line 36, and a second electrode of the ninth transistor M9 is connected to a third node N3.

One terminal of the second capacitor C2 is connected to a second node N2, and the other terminal of the second capacitor C2 is connected to the second clock signal line 36.

One terminal of the third capacitor C3 is connected to the first node N1, and the other terminal of the third capacitor C3 is connected to the first electrode of the ninth transistor M9.

The second node N2 outputs a second node voltage, and the third node N3 outputs a third node voltage.

A gate of the tenth transistor M10 is connected to the second node N2, a first electrode of the tenth transistor M10 is connected to the first voltage signal line 17, and a second electrode of the tenth transistor M10 is connected to the second electrode of the ninth transistor M9.

A gate of the first transistor M1 is connected to the third node N3, a first electrode of the first transistor M1 is connected to the first voltage signal line 17, and a second electrode of the first transistor M1 is connected to the first scan signal line 11.

A gate of the second transistor M2 is connected to the second node N2, a first electrode of the second transistor M2 is connected to the second voltage signal line 18, and a second electrode of the second transistor M2 is connected to the first scan signal line 11.

One terminal of the fourth capacitor C4 is connected to the third node N3, and the other terminal of the fourth capacitor C4 is connected to the first voltage signal line 17.

A first electrode of the eleventh transistor M11 is connected to the first clock signal line 35, a gate of the eleventh transistor M11 is connected to a second electrode of the eleventh transistor M11 to form a diode structure, and the second electrode of the eleventh transistor M11 is connected to a first electrode of the fourth transistor M4.

In the embodiment of the present disclosure, the first transistor M1 through the eleventh transistor M11 are all p-type transistors, with first electrodes as sources and second electrodes as drains. However, this is not limited in the present disclosure. In other embodiments of the present disclosure, all the transistors in the shift register unit 12 may also be n-type transistors.

The operating process of the shift register unit 12 shown in FIG. 8 is described in detail with reference to the operating timing diagram shown in FIG. 16 and using an example in which a first level is a low level, and a second level is a high level.

It is to be understood that the operating state of the shift register unit 12 in the previous stage affects the operating state of the shift register unit 12 in the subsequent stage. Therefore, before the description of the first stage T01, a certain description of the stage T00 preceding the first stage T01 is provided.

As shown in FIG. 16, in the stage T00, a signal at the input terminal IN and the first clock signal CK on the first clock signal line 35 remain at the first level, while the second clock signal XCK on the second clock signal line 36 is at the second level. In this case, the gate of the third transistor M3 and the gate of the fifth transistor M5 are connected to the low-level first clock signal CK, so the third transistor M3 and the fifth transistor M5 remain turned on in this stage. The low level input from the input terminal IN is transmitted to the second node N2 through the turned-on third transistor M3. Therefore, the fourth transistor M4, the tenth transistor M10, and the second transistor M2 are turned on. The second voltage VGL provided by the second voltage signal line 18 is transmitted to the first node N1 through the turned-on fifth transistor M5. The first voltage VGH transmitted on the first voltage signal line 17 is transmitted to the third node N3 through the turned-on tenth transistor M10, and the first transistor M1 is turned off. Therefore, in the stage T00, the first node N1 and the second node N2 are at a low-level voltage, the third node N3 is at a high-level voltage, and the second voltage VGL is output to the first scan signal line 11, that is, the first scan signal scan1 is at the second voltage VGL.

In the first stage T01, the signal at the input terminal IN and the second clock signal XCK on the second clock signal line 36 remain at the first level, while the first clock signal CK on the first clock signal line 35 is at the second level. In this case, the gate of the third transistor M3 and the gate of the fifth transistor M5 are connected to the high-level first clock signal CK, so the third transistor M3 and the fifth transistor M5 are turned off. In this stage, the second clock signal XCK changes from the high level in the stage T00 to a low level. Due to the coupling effect of the second capacitor C2, the voltage of the second node N2 decreases further. Since the second electrode of the eleventh transistor M11 is connected to the gate of the eleventh transistor M11, the eleventh transistor M11 acts as a diode connected to the entire circuit. In the first stage T01, the terminal of the diode-structured eleventh transistor M11 is connected to the high-level first clock signal CK, and the other terminal of the diode-structured eleventh transistor M11 is connected to the first node N1 through the turned-on fourth transistor M4. Since the first node N1 was at the low-level voltage in the previous stage T00, according to the forward-conduction and backward-turnoff characteristics of a diode, the eleventh transistor M11 is turned on in this stage. The high-level first clock signal CK is gradually transmitted to the first node N1 through the turned-on eleventh transistor M11 and the turned-on fourth transistor M4, causing the potential of the first node N1 to gradually rise from the low potential in the stage T00.

In the first stage T01, the first voltage VGH transmitted on the first voltage signal line 17 is transmitted to the third node N3 through the turned-on tenth transistor M10, and the first transistor M1 is turned off. Therefore, in the first stage T01, the first node N1 and the third node N3 are at a high-level voltage, the second node N2 is at a low-level voltage, and the second voltage VGL is output to the first scan signal line 11, that is, the first scan signal scan1 is at the second voltage VGL.

In the second stage T02, the first clock signal CK on the first clock signal line 35 is at the first level, while the signal at the input terminal IN and the second clock signal XCK on the second clock signal line 36 are at the second level. In this case, the gate of the third transistor M3 and the gate of the fifth transistor M5 are connected to the low-level first clock signal CK, so the third transistor M3 and the fifth transistor M5 are turned on; the second voltage VGL provided by the second voltage signal line 18 is transmitted to the first node N1 through the turned-on fifth transistor M5, and the eighth transistor M8 is turned on; the high-level signal input from the input terminal IN is transmitted to the second node N2 through the turned-on third transistor M3. Therefore, the fourth transistor M4, the tenth transistor M10, and the second transistor M2 are turned off, while the third node N3 remains at the high-level voltage in the previous first stage T01. Therefore, in the first stage T01, the first node N1 is at a low-level voltage, the third node N3 and the second node N2 are at a high-level voltage, and the first scan signal scan1 remains at the second voltage VGL in the previous stage.

In the third stage T03, the first clock signal CK on the first clock signal line 35 is at the second level, while the signal at the input terminal IN and the second clock signal XCK on the second clock signal line 36 are at the first level. In this case, the gate of the third transistor M3 and the gate of the fifth transistor M5 are connected to the high-level first clock signal CK, so the third transistor M3 and the fifth transistor M5 are turned off. Therefore, the first node N1 remains at the low-level voltage in the previous second stage T02, and the seventh transistor M7 and the eighth transistor M8 are turned on. The gate of the sixth transistor M6 and the gate of the ninth transistor M9 are connected to the low-level second clock signal XCK, so the sixth transistor M6 and the ninth transistor M9 are turned on. Therefore, in the third stage T03, the first voltage VGH transmitted on the first voltage signal line 17 is transmitted to the second node N2 through the turned-on sixth transistor M6 and the turned-on seventh transistor M7, while the tenth transistor M10 and the second transistor M2 are turned off; the low-level second clock signal XCK is transmitted to the third node N3 through the turned-on eighth transistor M8 and the turned-on ninth transistor M9. Therefore, in the third stage T03, the first node N1 and the third node N3 are at a low-level voltage, the second node N2 is at a high-level voltage, and the first voltage VGH is output to the first scan signal line 11, that is, the first scan signal scan1 is at the first voltage VGH.

In the fourth stage T04, the first clock signal CK on the first clock signal line 35 and the signal at the input terminal IN are at the first level, while the second clock signal XCK on the second clock signal line 36 is at the second level. In this case, the gate of the third transistor M3 and the gate of the fifth transistor M5 are connected to the low-level first clock signal CK, so the third transistor M3 and the fifth transistor M5 are turned on; the second voltage VGL provided by the second voltage signal line 18 is transmitted to the first node N1 through the turned-on fifth transistor M5, and the eighth transistor M8 is turned on; the low-level signal input from the input terminal IN is transmitted to the second node N2 through the turned-on third transistor M3. Therefore, the fourth transistor M4, the tenth transistor M10, and the second transistor M2 are turned on. The first voltage VGH transmitted on the first voltage signal line 17 is transmitted to the third node N3 through the turned-on tenth transistor M10, and the first transistor M1 is turned off. Therefore, in the fourth stage T04, the first node N1 and the second node N2 are at the low-level voltage, the third node N3 is at the high-level voltage, and the second voltage VGL is output to the first scan signal line 11, that is, the first scan signal scan1 is at the second voltage VGL.

In the fifth stage T05, the signal at the input terminal IN and the second clock signal XCK on the second clock signal line 36 are at the first level, while the first clock signal CK on the first clock signal line 35 is at the second level. In this case, the gate of the third transistor M3 and the gate of the fifth transistor M5 are connected to the high-level first clock signal CK, so the third transistor M3 and the fifth transistor M5 are turned off. In this stage, the second clock signal XCK changes from the high level in the fourth stage T04 to a low level. Due to the coupling effect of the second capacitor C2, the voltage of the second node N2 decreases further. The first voltage VGH transmitted on the first voltage signal line 17 is transmitted to the third node N3 through the turned-on tenth transistor M10, and the first transistor M1 is turned off. Therefore, in the fifth stage T05, the first node N1 and the third node N3 are at the high-level voltage, the second node N2 is at the low-level voltage, and the second voltage VGL is output to the first scan signal line 11, that is, the first scan signal scan1 is at the second voltage VGL.

It can be seen from the preceding analysis that the fifth stage T05 starts to repeat the operation of the first stage T01. Therefore, the operating cycle of the shift register unit 12 spans from T01 to T04.

Furthermore, the first modulation control signal line 15A is selectively electrically connected to the first clock signal line 35 or the second clock signal line 36, thereby reusing an existing clock signal as the modulation control signal.

In some embodiments, as shown in FIG. 15, the first modulation control signal line 15A is electrically connected to the first clock signal line 35 so that the modulation control signal applied to the gate of the modulation transistor 13 is the same as the first clock signal CK.

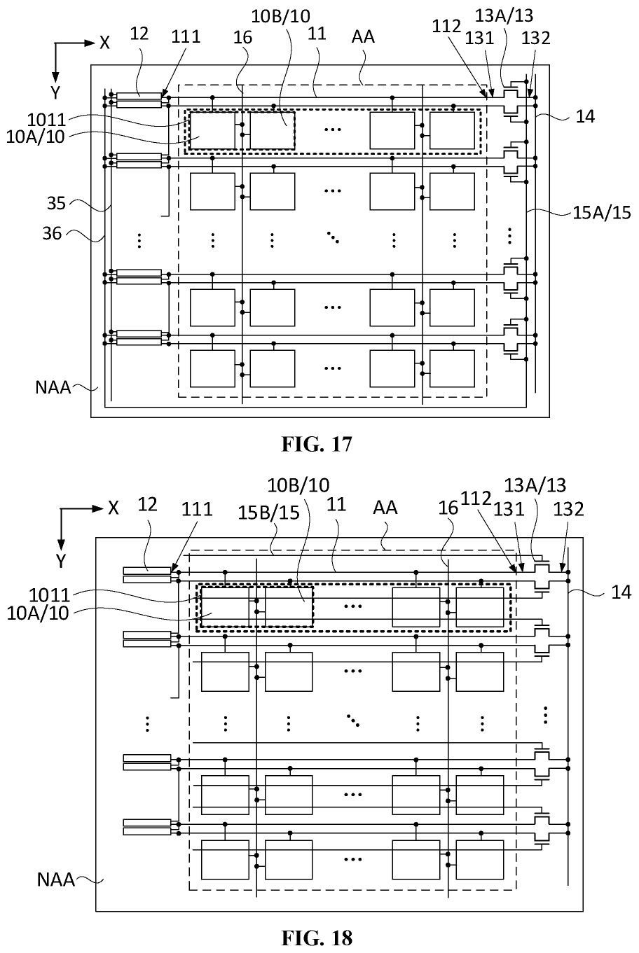

FIG. 17 is another diagram illustrating the structure of a display panel according to an embodiment of the present disclosure. As shown in FIG. 17, for example, the first modulation control signal line 15A is electrically connected to the second clock signal line 36 so that the modulation control signal is the same as the second clock signal XCK.

Since the first clock signal CK and the second clock signal XCK are inverted with respect to each other, the two preceding connections may correspond to different modulation trigger timings, respectively. Using the first switch transistor T1 being the n-type transistor as an example, when the first scan signal scan1 needs to be rapidly pulled down in the falling edge stage (that is, the switching stage T0), if the modulation transistor 13 is also an n-type transistor, a high-level control signal is required to turn on the modulation transistor 13. In this case, the first modulation control signal line 15A may be connected to the second clock signal line 36, because the second clock signal XCK on the second clock signal line 36 is at a high level in the falling edge stage of the first scan signal scan1. This can allow the modulation transistor 13 to be turned on at the appropriate moment, thereby pulling down the first scan signal scan1 on the first scan signal line 11 to the modulation voltage.

In some embodiments, when the first switch transistor T1 is the n-type transistor, and the modulation transistor 13 is a p-type transistor, the first modulation control signal line 15A may also be selectively connected to the first clock signal line 35 so that the modulation control signal reuses the first clock signal CK, which is not specifically limited in the embodiment of the present disclosure.

In this embodiment, the modulation control signal on the first modulation control signal line 15A directly reuses the first clock signal CK or the second clock signal XCK that is used by the shift register unit 12. This can eliminate the need for an independent logic circuit or wiring to generate a modulation pulse, effectively reduce the wiring density, and facilitate the high pixel density and the narrow-bezel design.

In addition, the first clock signal CK and the second clock signal XCK are the core clocks generated by the first scan signal scan1, and their phases are strictly correlated with the rising/falling edge of the first scan signal scan1. Therefore, reusing the first clock signal CK or the second clock signal XCK as the modulation control signal can ensure that the modulation transistor 13 is turned on at the moment when pull-down (or pull-up) is required, thereby avoiding modulation failure caused by additional delay.

FIG. 18 is another diagram illustrating the structure of a display panel according to an embodiment of the present disclosure. As shown in FIG. 18, for example, the display panel includes a display region AA. The multiple modulation control signal lines 15 further include multiple second modulation control signal lines 15B at least partially located in the display region AA. The extending direction of the multiple second modulation control signal lines 15B is the same as the extending direction of the multiple first scan signal lines 11.

In an embodiment, as shown in FIG. 18, the display region AA refers to a region of the display panel that is actually used to display images, text, or other visual content. The light-emitting elements 20 are arranged within the display region AA, and various images are presented by controlling the brightness of the light-emitting elements 20.

At least one side of the display region AA is provided with a non-display region NAA. The non-display region NAA is located at the edge of the display panel. This region does not participate in image display, but includes some necessary circuit structures and lines, such as a driving integrated circuit (IC) and signal lines, for supporting the operation of the display region AA.

As shown in FIG. 18, the second modulation control signal lines 15B extend within the display region AA, and the extending direction is the same as that of the first scan signal lines 11, for example, arranged along the row direction and in parallel with the multiple first scan signal lines 11.

In some embodiments, as shown in FIG. 18, the second modulation control signal lines 15B are used to transmit modulation control signals to modulation transistors 13 located in the non-display region NAA.

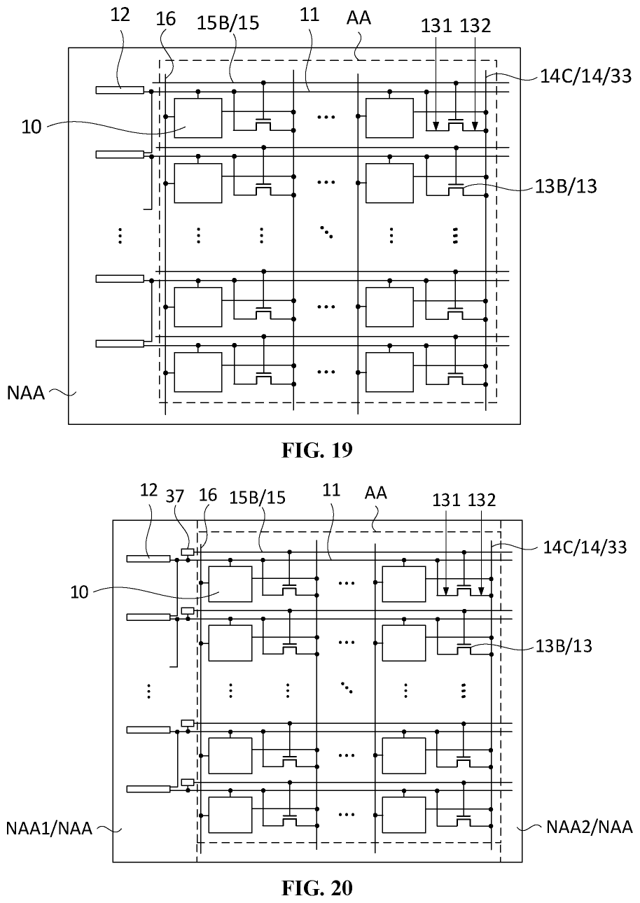

FIG. 19 is another diagram illustrating the structure of a display panel according to an embodiment of the present disclosure. As shown in FIG. 19, for example, the second modulation control signal lines 15B are used to transmit the modulation control signals to the modulation transistors 13 located within the display region AA. The modulation control signals can be introduced from the non-display region NAA into the display region AA through the second modulation control signal lines 15B and extend along the row direction throughout the display region AA, enabling synchronous control of modulation transistors 13 in an entire row or a local region.

In this embodiment, by extending the second modulation control signal lines 15B into the display region AA, the modulation transistors 13 located within the display region AA can be driven directly. This can avoid modulation response delay or attenuation that may occur if the modulation transistors 13 receive the modulation voltages only from one side of the non-display region NAA, thereby more effectively providing compensation to the RC delay of the first scan signal lines 11 and improving waveforms of the first scan signals scan1.

Moreover, since the second modulation control signal lines 15B extend in the same direction as the first scan signal lines 11 (for example, along the row direction), multiple modulation transistors 13 can be distributed along the entire row of the first scan signal line 11. This can allow modulation transistors 13 at different positions to receive modulation control signals at nearly the same time, ensuring that the auxiliary pull-down/pull-up operations at the different positions are highly synchronized in time. As a result, first switch transistors T1 of the entire row of pixel driving circuits 10 can be turned off synchronously, thereby improving the charging consistency.

FIG. 20 is another diagram illustrating the structure of a display panel according to an embodiment of the present disclosure. As shown in FIG. 20, for example, the display panel further includes multiple modulation control signal generation units 37. An input terminal of a modulation control signal generation unit 37 is electrically connected to the first scan signal line 11 to receive the first scan signal scan1, and an output terminal of the modulation control signal generation unit 37 is electrically connected to a second modulation control signal line 15B. The modulation control signal generation unit 37 is configured to provide the modulation control signal to the second modulation control signal line 15B.

In an embodiment, as shown in FIG. 20, the input terminal of the modulation control signal generation unit 37 receives the first scan signal scan1 from the first scan signal line 11 in real time, and the output terminal of the modulation control signal generation unit 37 provides the modulation control signal to the modulation transistors 13 connected to the first scan signal line 11.

The modulation control signal generation units 37 may be integrated within the non-display region NAA or distributed within the display region AA, with the function of automatically generating the corresponding modulation control signals based on the received first scan signals scan1.

In some embodiments, the modulation control signal generation unit 37 may be composed of one or more logic gate circuits (such as an inverter, a delay unit, and an edge detection circuit). For example, when the first scan signal scan1 hops from the turn-on voltage V11 to the turn-off voltage V12, the modulation control signal generation unit 37 can detect the falling edge or the rising edge and output a short valid pulse. This pulse is used to turn on the modulation transistor 13 in the falling or rising edge stage of the first scan signal scan1 (that is, the switching stage T0), thereby accelerating the switching process of the first scan signal line 11.

Since the modulation control signal is generated by the first scan signal scan1, the timing of the modulation control signal is highly synchronized with that of the first scan signal scan1, without relying on an external global clock (such as the first clock signal CK/the second clock signal XCK) or other independent control signals, which can avoid a timing deviation caused by the difference in signal paths.

In addition, modulation control signal generation units 37 can be disposed in multiple rows or key regions, respectively, forming a distributed modulation network. Each modulation control signal generation unit 37 responds only to the first scan signal scan1 of the row in which the modulation control signal generation unit 37 is located, effectively handling RC load differences among first scan signals scan1 in different rows and improving the display uniformity.

In some embodiments, as shown in FIG. 20, the display panel further includes the non-display region NAA located on at least one side of the display region AA. The non-display region NAA includes a first non-display region NAA1 located on one side of the display region AA, and the shift register units 12 and the modulation control signal generation units 37 are disposed in the first non-display region NAA1.

In this layout, the shift register units 12 generate the first scan signals scan1 in a stage-by-stage manner based on a clock signal (such as the first clock signal CK/the second clock signal XCK) and transmit the first scan signals scan1 to rows of pixel driving circuits 10 within the display region AA through the first scan signal lines 11. Moreover, the input terminal of the modulation control signal generation unit 37 is electrically connected to the first scan signal line 11 to receive the signal from the first scan signal line 11 in real time, and the output terminal of the modulation control signal generation unit 37 is electrically connected to the second modulation control signal line 15B to generate and output the corresponding modulation control signal, which drives the modulation transistor 13 to turn on in the switching stage T0, thereby actively performing pull-down or pull-up regulation on the first scan signal line 11.

Since the shift register unit 12 and the modulation control signal generation unit 37 are located in the non-display region NAA1 on the same side, efficient signal interaction can be achieved through short-distance and low-latency wiring. For example, when the first scan signal scan1 on the first scan signal line 11 switches from the turn-on voltage V11 to the turn-off voltage V12, the modulation control signal generation unit 37 can quickly generate the valid pulse K01 of the modulation control signal K0 based on the waveform of a near-end first scan signal scan1. This valid pulse K01 synchronously triggers multiple modulation transistors 13 through the second modulation control signal line 15B (which may extend into the display region AA), thereby providing auxiliary regulation to the entire row of the first scan signal scan1.

It is to be understood that the shift register unit 12 and the modulation control signal generation unit 37 are located in the same non-display region NAA1, and the connection path between the shift register unit 12 and the modulation control signal generation unit 37 is relatively short, which can avoid the parasitic effect and timing deviation that are caused by long inter-region wiring, thereby ensuring that the valid pulse K01 of the modulation control signal K0 can closely change with the first scan signal scan1 and improving response accuracy.

Moreover, disposing the shift register unit 12 and the modulation control signal generation unit 37 only in the non-display region NAA on the same side of the display panel (such as the first non-display region NAA1) can significantly reduce the bezel size on the opposite side of the display panel, thereby achieving a high screen-to-body ratio.

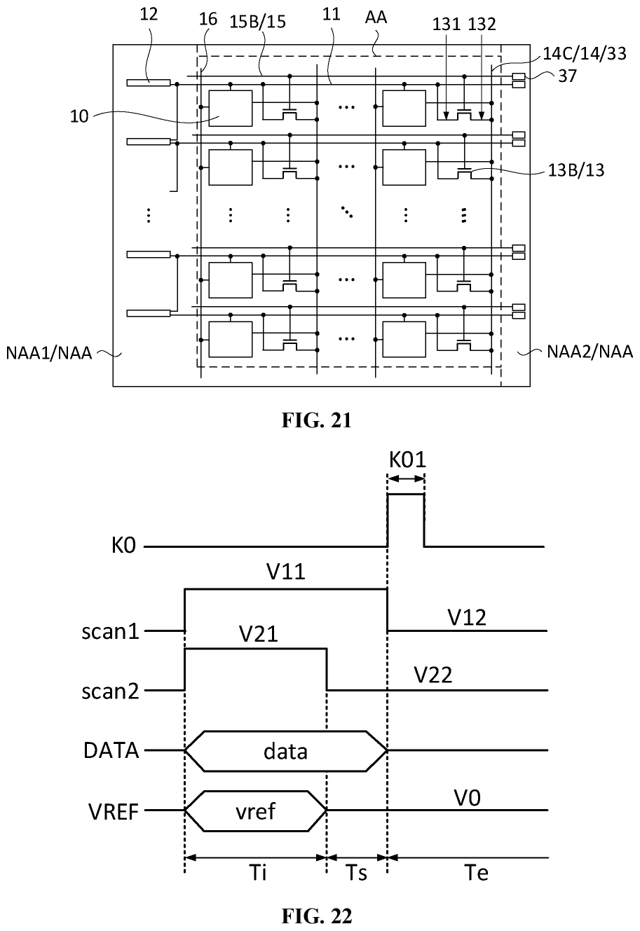

FIG. 21 is another diagram illustrating the structure of a display panel according to an embodiment of the present disclosure. As shown in FIG. 21, for example, the display panel further includes a non-display region NAA located on at least one side of the display region AA. The non-display region NAA includes a first non-display region NAA1 and a second non-display region NAA2 that are located on two opposite sides of the display region AA, respectively. The display panel further includes multiple modulation control signal generation units 37. An output terminal of a modulation control signal generation unit 37 is electrically connected to a second modulation control signal line 15B. The modulation control signal generation unit 37 is configured to provide the modulation control signal to the second modulation control signal line 15B. The multiple shift register units 12 are located in the first non-display region NAA1. The multiple modulation control signal generation units 37 are located in the second non-display region NAA2.

In this embodiment, the non-display region NAA is divided into the first non-display region NAA1 and the second non-display region NAA2 that are located on the two opposite sides of the display region AA, respectively.

The shift register unit 12 is disposed in the first non-display region NAA1, thereby ensuring that the arrangement of sub-pixels in the display region AA is not interfered with and improving the aperture ratio. This can facilitate enhanced brightness, energy efficiency, and display uniformity.

The modulation control signal generation unit 37 is disposed in the second non-display region NAA2, and the output terminal of the modulation control signal generation unit 37 is directly electrically connected to the second modulation control signal line 15B, so as to generate and transmit the modulation control signal to the second modulation control signal line 15B.

The modulation control signal generation unit 37 outputs the valid pulse K01 of the modulation control signal K0 within a precise timing window based on a specific input, so as to drive the modulation transistor 13 to actively regulate (such as pull down or pull up) the first scan signal scan1 on the first scan signal line 11, thereby improving the waveform of the first scan signal scan1 and suppressing the impact of the RC delay.

An input terminal of the modulation control signal generation unit 37 may be flexibly configured as required. For example, the input terminal of the modulation control signal generation unit 37 is electrically connected to the first scan signal line 11, so as to respond to level changes of the first scan signal scan1 in real time. The modulation control signal generation unit 37 may be composed of a first-stage inverter, a delay unit, and a NAND gate, so as to implement falling-edge or rising-edge detection.

In some embodiments, the input terminal of the modulation control signal generation unit 37 may also be connected to an internal node of the shift register unit 12, so as to obtain a steeper signal edge or lower noise.

In some embodiments, the input terminal of the modulation control signal generation unit 37 may also be connected to a clock signal line (such as the first clock signal line 35 or the second clock signal line 36). By logically combining a clock signal with the first scan signal scan1 or an enable signal, a modulation control signal that is valid only within a specific row cycle can be generated.

In some embodiments, the input terminal of the modulation control signal generation unit 37 may also be connected to a global enable signal or a frame synchronization signal (such as STV or OE). For example, the input terminal may receive a global control signal from a timing controller (TCON), thereby ensuring that a modulation operation is activated only during the valid display period and reducing static power consumption.

In this embodiment, as shown in FIG. 21, the modulation control signal generation unit 37 and the shift register unit 12 are disposed in the non-display regions NAA on the two opposite sides of the display region AA (such as the first non-display region NAA1 and the second non-display region NAA2), respectively. In this layout, the first scan signal scan1 is output from the first non-display region NAA1 and transmitted to the entire display region AA through the first scan signal line 11; the modulation control signal is output from the second non-display region NAA2 and transmitted through the second modulation control signal line 15B in a direction opposite to the transmission direction of the first scan signal scan1, thereby forming a signal transmission path in which the first scan signal scan1 and the modulation control signal propagate toward each other.

When the first scan signal scan1 experiences a slowed falling or rising edge at the far end (near the second non-display region NAA2) due to the RC delay, the modulation control signal starts from the far end and preferentially acts on a modulation transistors 13 in this region, thereby rapidly pulling down or pulling up the first scan signal scan1 on the first scan signal line 11 to the modulation voltage. This can ensure that the pull-down or pull-up operation occurs more rapidly and timely at the position where the RC delay is most severe, thereby improving the charging consistency and the display uniformity.

In one or more embodiments, as shown in FIGS. 7 and 8, the start moment of the valid pulse K01 of the modulation control signal K0 is the same as the start moment of the switching stage T0 of the first scan signal scan1.

In an embodiment, as shown in FIGS. 7 and 8, when the first scan signal scan1 enters the switching stage T0, the modulation control signal K0 immediately outputs the valid pulse K01 to turn on the modulation transistor 13. Since the start moment of the valid pulse K01 is strictly aligned with the start moment of the switching stage T0 in timing, the modulation transistor 13 may be turned on at the very moment the potential of the first scan signal scan1 starts to fall or rise. This can allow the first scan signal scan1 on the first scan signal line 11 to be rapidly pulled down or pulled up to the modulation voltage through a low-impedance path, thereby effectively suppressing a signal slow-down situation caused by the line parasitic resistor (R) and capacitor (C). As a result, the first switch transistor T1 connected to the first scan signal line 11 can be turned off almost simultaneously, thereby improving the display uniformity.

FIG. 22 is another operating timing diagram of a pixel driving circuit according to an embodiment of the present disclosure. As shown in FIG. 22, for example, the pulse width of the valid pulse K01 of the modulation control signal K0 is shorter than the duration of the turn-off voltage V12 of the first scan signal scan1.

In an embodiment, the first scan signal scan1 provides the turn-on voltage V11 and the turn-off voltage V12 in each row cycle. The duration of the turn-off voltage V12 typically spans the entire non-gating period from the end of the turn-on voltage V11 of the first scan signal scan1 until the next row is provided with the turn-on voltage V11 again. The length of the duration of the turn-off voltage V12 may depend on the resolution and refresh rate of the display panel.

In this embodiment, the valid pulse K01 is provided only in the initial stage in which the first scan signal scan1 switches to the turn-off voltage V12 (such as the switching stage T0), and the pulse width of the valid pulse K01 is shorter than the total duration of the turn-off voltage V12. This can prevent interference with the normal operation of other operating stages (such as the initialization stage Ti and the sensing stage Ts that correspond to the turn-on voltage V11).

In some embodiments, the slowed falling or rising edge of the first scan signal scan1 caused by the RC delay is mainly concentrated in the switching stage T0, and the first scan signal scan1 has already stabilized subsequently. Therefore, the valid pulse K01 covers only the switching stage T0, which can avoid unnecessary conduction during the steady-state period of the first scan signal scan1 and reduce power consumption.

It is to be understood that if the valid pulse K01 were to last for the entire stage of the turn-off voltage V12, the modulation transistor 13 would remain turned on for a long time, which not only increases leakage currents but also potentially causes power supply noise or voltage fluctuations due to continuous discharging. Employing a narrow valid pulse K01 can significantly reduce the conduction time of the modulation transistor 13, thereby effectively suppressing the power consumption. Moreover, this can also reduce the risk of coupling interference between the modulation control signal K0 and other signal lines, thereby improving overall timing robustness.

In one or more embodiments, as shown in FIGS. 1, 3, and 22, the display panel further includes multiple light-emitting elements 20 arranged in an array, and the multiple light-emitting elements 20 are electrically connected to the multiple pixel driving circuits 10. A pixel driving circuit 10 includes a driving transistor T3, a first switch transistor T1, and a second switch transistor T2, and the driving transistor T3 and a light-emitting element 20 are connected in series between a first power voltage signal line 31 and a second power voltage signal line 32. A gate of the driving transistor T3 is electrically connected to a first terminal t11 of the first switch transistor T1, a second terminal t12 of the first switch transistor T1 is electrically connected to a data signal line 16, and a gate of the first switch transistor T1 is electrically connected to the first scan signal line 11. A first terminal t21 of the second switch transistor T2 is electrically connected to a first terminal t31 of the driving transistor T3, a second terminal t22 of the second switch transistor T2 is electrically connected to a reference voltage signal line 33, and a gate of the second switch transistor T2 is electrically connected to a second scan signal line 34. The pixel driving circuit 10 has a light-emitting stage Te in which the first switch transistor T1 and the second switch transistor T2 are turned off. The pulse width of the valid pulse K01 of the modulation control signal K0 is shorter than the duration of the light-emitting stage Te.

The specific structures and operating processes of the light-emitting element 20 and the pixel driving circuit 10 can be referred to any of the preceding embodiments and are not repeated herein.

In this embodiment, during a normal operating cycle, the pixel driving circuit 10 undergoes multiple operation stages including the light-emitting stage Te. In this stage, the first switch transistor T1 and the second switch transistor T2 are in an off state, and the driving transistor T3 maintains a constant driving current based on a data signal voltage stored at the gate of the driving transistor T3, thereby allowing the light-emitting element 20 to emit light stably without being affected by external signals.

Furthermore, the pulse width of the valid pulse K01 of the modulation control signal K0 is shorter than the duration of the light-emitting stage Te so that the valid pulse K01 occurs only in the light-emitting stage Te, thereby avoiding interference with the normal operation of other operating stages (such as the initialization stage Ti and the sensing stage Ts that correspond to the turn-on voltage V11).

In some embodiments, the valid pulse K01 of the modulation control signal K0 only covers the switching stage T0, thereby ensuring that the modulation operation acts only in the initial stage in which the first scan signal scan1 switches to the turn-off voltage V12 (such as the switching stage T0). During most of the light-emitting stage Te, the modulation transistor 13 remains turned off so that no additional load or noise is introduced into the pixel driving circuit 10, thereby avoiding interference with the stable light-emitting process.

In one or more embodiments, as shown in FIG. 1, the display panel further includes a display region AA and a non-display region NAA located on at least one side of the display region AA. The multiple modulation transistors 13 include multiple first modulation transistors 13A, and the multiple first modulation transistors 13A are located within the non-display region NAA. A shift register unit 12 is connected to a first end 111 of the first scan signal line 11, and a first modulation transistor 13A is connected to a second end 112 of the first scan signal line 11.

In an embodiment, the first scan signal line 11 has the first end 111 and the second end 112 and extends across the entire display region AA along the row direction, so as to transmit the first scan signal scan1 to gates of first switch transistors T1 of a row of pixel driving circuits 10 corresponding to the first scan signal line 11.

The shift register unit 12 is connected to the first end 111 of the first scan signal line 11 so that a required first scan signal scan1 is provided to each row of a first scan signal line 11 in a row-by-row scanning manner. The shift register unit 12 may be disposed within the non-display region NAA on one side of the first end 111 of the first scan signal line 11 so that the shift register unit 12 can be kept out of the display region AA, cannot occupy effective pixel space, and cannot block the light-emitting path of the light-emitting element 20, thereby avoiding any adverse impact on the display effect of the display region AA.

Furthermore, disposing modulation transistors 13, that is, the first modulation transistors 13A, within the non-display region NAA can reduce the impact of the first modulation transistors 13A on the display effect of the display region AA and facilitate the increased screen-to-body ratio.

The RC delay accumulates with the transmission distance, and the far end (a region facing away from one side of the shift register unit 12) is a region in which distortion of the first scan signal scan1 is more severe. In this embodiment, the first modulation transistor 13A is connected to the second end 112 of the first scan signal line 11, and the first modulation transistor 13A and the shift register unit 12 are located on two opposite sides of the display region AA, respectively, so that the first modulation transistor 13A is disposed at the far-end position. Accordingly, in the switching stage T0 of the first scan signal scan1, the first modulation transistor 13A can be rapidly turned on to pull down or pull up the first scan signal line 11 to the modulation voltage through a low-impedance path, thereby effectively accelerating the potential switching at the far end. This can ensure that the time of the falling edge or rising edge of the first scan signal scan1 along the entire first scan signal line 11 tends to be consistent so that first switch transistors T1 of pixel driving circuits 10 are turned off almost simultaneously, thereby improving charging timing consistency and the display uniformity.

In some embodiments, as shown in FIGS. 1 and 10, the first voltage signal line 17 and the second voltage signal line 18 are located in the non-display region NAA and thereby do not occupy the effective area of the display region AA, thereby avoiding any impact on pixel arrangement and light-emitting performance. The first modulation transistor 13A is electrically connected to the first modulation voltage signal line 14A, and the first modulation voltage signal line 14A is electrically connected to the first voltage signal line 17 or the second voltage signal line 18. In this manner, all these wirings are located in the non-display region NAA, which can avoid noise coupling caused by signal lines crossing high-density sub-pixels, thereby effectively reducing line voltage drop and parasitic effects, and ensuring that the modulation voltage is stably and reliably applied to the first modulation transistor 13A without adversely affecting the display effect of the display region AA.

In some embodiments, as shown in FIGS. 15 and 17, the first clock signal line 35 and the second clock signal line 36 are located in the non-display region NAA and thereby do not occupy the effective area of the display region AA, thereby avoiding any impact on the pixel arrangement and the light-emitting performance. The first modulation transistor 13A is electrically connected to the first modulation control signal line 15A, and the first modulation control signal line 15A is electrically connected to the first clock signal line 35 or the second clock signal line 36. In this manner, all these wirings are located in the non-display region NAA, which can avoid noise coupling caused by signal lines crossing the high-density sub-pixels, thereby effectively reducing line voltage drop and parasitic effects, and ensuring that the modulation control signal is stably and reliably applied to the first modulation transistor 13A without adversely affecting the display effect of the display region AA.

In one or more embodiments, as shown in FIGS. 1 and 3, the display panel further includes multiple light-emitting elements 20 arranged in an array, and the multiple light-emitting elements 20 are electrically connected to the multiple pixel driving circuits 10. A pixel driving circuit 10 includes a driving transistor T3, a first switch transistor T1, and a second switch transistor T2, and the driving transistor T3 and a light-emitting element 20 are connected in series between a first power voltage signal line 31 and a second power voltage signal line 32. A gate of the driving transistor T3 is electrically connected to a first terminal t11 of the first switch transistor T1, a second terminal t12 of the first switch transistor T1 is electrically connected to a data signal line 16, and a gate of the first switch transistor T1 is electrically connected to the first scan signal line 11. The channel width-to-length ratio of the first modulation transistor 13A is greater than or equal to the channel width-to-length ratio of the first switch transistor T1.

The specific structures and functions of the light-emitting element 20 and the pixel driving circuit 10 can be referred to any of the preceding embodiments and are not repeated herein.

It is to be noted that during transmission on the first scan signal line 11, the falling edge or rising edge of the first scan signal scan1 at the far end becomes gradually slowed due to the RC delay. If the driving capability of the first modulation transistor 13A is insufficient to rapidly pull the first scan signal scan1 to the turn-off voltage V12, the first switch transistor T1 is turned off with delay, thereby affecting the charging accuracy of sub-pixels at the far end.

In this embodiment, the channel width-to-length ratio of the first modulation transistor 13A is configured to be greater than or equal to that of the first switch transistor T1. The channel width-to-length ratio refers to the ratio W/L of the channel width W of a transistor to the channel length L of the transistor, which directly determines the conduction capability of the transistor (that is, transconductance and driving current capability of the transistor). Therefore, having a relatively large channel width-to-length ratio can enable the first modulation transistor 13A to possess a stronger pull-down or pull-up driving capability, thereby achieving efficient and rapid active pull-down or pull-up at the far end and effectively addressing the signal delay at the far end.

In one or more embodiments, as shown in FIGS. 19 to 21, the multiple modulation transistors 13 include multiple second modulation transistors 13B that are located in the display region AA.

Unlike the first modulation transistor 13A that is located in the non-display region NAA, a second modulation transistor 13B is disposed within the display region AA, with the physical position being close to or directly integrated into the pixel driving circuit 10. With this arrangement, the pull-down or pull-up operation of the second modulation transistor 13B can directly act on the first scan signal scan1 at the position of the pixel driving circuit 10, facilitating local fine modulation, improving the response speed and consistency of pixel driving circuits 10 in different regions, enhancing the consistency of charging times, and thereby improving the display uniformity.

In some embodiments, as shown in FIGS. 19 to 21, the reference voltage signal line 33 is located in the display region AA to provide the reference voltage vref to the second switch transistor T2 in the pixel driving circuits 10 within the display region AA, thereby supporting operations such as initialization or threshold voltage compensation. The second modulation transistor 13B within the display region AA is connected to the third modulation voltage signal line 14C, and the third modulation voltage signal line 14C is the same signal line as the reference voltage signal line 33, so as to reuse the existing reference voltage signal line 33, thereby requiring no additional wiring, saving the space in the display region AA, and facilitating the high-resolution integrated design.

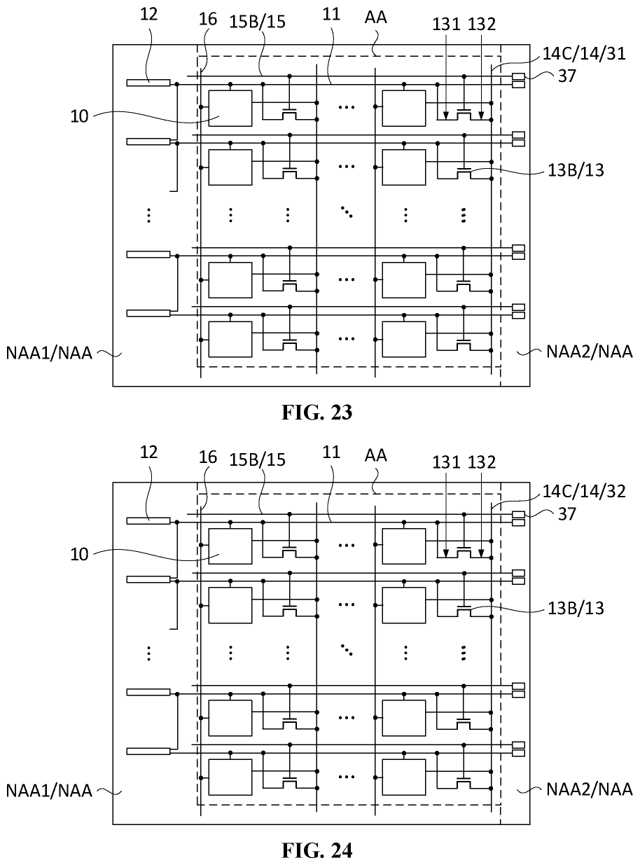

FIG. 23 is another diagram illustrating the structure of a display panel according to an embodiment of the present disclosure. FIG. 24 is another diagram illustrating the structure of a display panel according to an embodiment of the present disclosure. As shown in FIGS. 23 and 24, for example, the first power voltage signal line 31 and the second power voltage signal line 32 are also located within the display region AA to provide the required power voltages to the pixel driving circuit 10 within the display region AA. The second modulation transistor 13B is connected to the second modulation voltage signal line 14B, and the second modulation voltage signal line 14B is the same signal line as the first power voltage signal line 31 or the second power voltage signal line 32. By reusing the existing power voltage signal line, no additional wiring is required, thereby saving the space in the display region AA and facilitating the high-resolution integrated design.

In some embodiments, as shown in FIGS. 19 to 21, the second modulation control signal line 15B is located within the display region AA and is connected to the second modulation transistor 13B, so as to provide the modulation control signal to the second modulation transistor 13B within the display region AA.

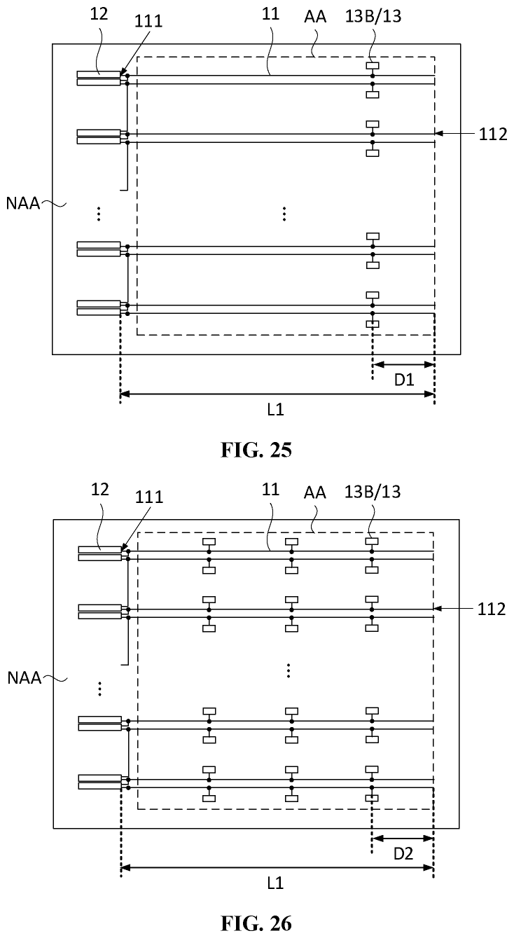

FIG. 25 is another diagram illustrating the structure of a display panel according to an embodiment of the present disclosure. As shown in FIG. 25, for example, the first scan signal line 11 is connected to one second modulation transistor 13B. A shift register unit 12 is connected to a first end 111 of the first scan signal line 11. The length of the first scan signal line 11 is L1, and the distance between the second modulation transistor 13B and a second end 112 of the first scan signal line 11 is D1, where D1≤L1/3.

In an embodiment, the first scan signal line 11 has the first end 111 and the second end 112 and extends across the entire display region AA along the row direction. The first scan signal line 11 is connected to the second modulation transistor 13B, which can reduce the impact of the second modulation transistor 13B on the display effect of the display region AA and lower costs.

The shift register unit 12 is disposed within the non-display region NAA and is electrically connected to the first end 111 of the first scan signal line 11, so as to generate and output the first scan signal scan1 to drive the row of pixel driving circuits 10 corresponding to the first scan signal line 11.

In this embodiment, the first scan signal line 11 has a total length L1, where the total length L1 may be understood as the distance between the first end 111 of the first scan signal line 11 and the second end 112 of the first scan signal line 11.

The distance D1 between the second modulation transistor 13B and the second end 112 of the first scan signal line 11 may be understood as the distance between the connection position at which the second modulation transistor 13B is connected to the first scan signal line 11 and the second end 112 of the first scan signal line 11.

D1≤L1/3 such that the second modulation transistor 13B is disposed within a one-third region close to the far end (that is, the second end 112) of the first scan signal line 11. This position is determined based on a comprehensive consideration of RC delay distribution characteristics and signal integrity requirements. Since signal attenuation and slowed falling edge or rising edge accumulate with the distance during the transmission of the first scan signal scan1 from the first end 111 of the first scan signal line 11 to the second end 112 of the first scan signal line 11, signal degradation becomes relatively severe in a far-end region (particularly in the last one-third segment). Therefore, disposing the second modulation transistor 13B within the one-third region close to the far end (that is, the second end 112) of the first scan signal line 11 can ensure that the pull-down or pull-up effect covers a region in which the first scan signal scan1 is prone to degradation. As a result, under the condition that only the one second modulation transistor 13B is provided, the difference in effective charging times between the near and far ends can be reduced, thereby improving the display uniformity.

FIG. 26 is another diagram illustrating the structure of a display panel according to an embodiment of the present disclosure. As shown in FIG. 26, for example, the first scan signal line 11 is connected to N second modulation transistors 13B, where N≥2. A shift register unit 12 is connected to a first end 111 of the first scan signal line 11. The length of the first scan signal line 11 is L1, and the distance between a second end 112 of the first scan signal line 11 and a second modulation transistor 13B that is closest to the second end 112 of the first scan signal line 11 is D2, where D2≤L1/(N+1).

In an embodiment, as shown in FIG. 26, the first scan signal line 11 is connected to the N second modulation transistors 13B, where N≥2. That is, the first scan signal line 11 is connected to at least two second modulation transistors 13B. The second modulation transistors 13B are all disposed within the display region AA, and first terminals of the second modulation transistors 13B are electrically connected to different positions on the first scan signal line 11, respectively. During the valid pulse K01 of the modulation control signal K0, the first scan signal scan1 at the different positions can be actively pulled down or pulled up, thereby reducing differences in effective charging times of pixel driving circuits 10 at the different positions and improving the display uniformity.

Moreover, the shift register unit 12 is disposed within the non-display region NAA and is electrically connected to the first end 111 of the first scan signal line 11. The shift register unit 12 serves as a driving source of the first scan signal scan1 and provides the first scan signal scan1 to the entire first scan signal line 11.

In this embodiment, the total length of the first scan signal line 11 is L1, and the distance between the second end 112 of the first scan signal line 11 and the second modulation transistor 13B that is closest to the second end 112 of the first scan signal line 11 is defined as D2, where it is satisfied that D2≤L1/(N+1). Herein, the distance D2 refers to the wiring length of a line between an electrical connection point of the second modulation transistor 13B to the first scan signal line 11 and the second end 112.

When the preceding condition is satisfied, the position of a second modulation transistor 13B closest to the far end is constrained to be within a range not exceeding L1/(N+1) from the second end 112. This can ensure that the pull-down or pull-up effect covers the far-end region in which the first scan signal scan1 is prone to degradation, thereby reducing the difference in effective charging times between the near and far ends and improving the display uniformity.

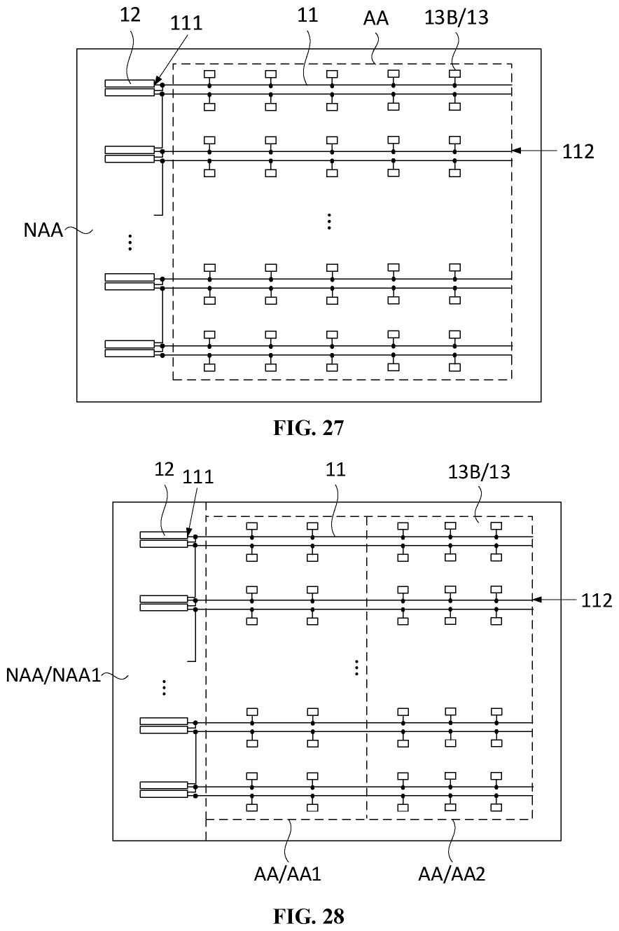

FIG. 27 is another diagram illustrating the structure of a display panel according to an embodiment of the present disclosure. As shown in FIG. 27, for example, the first scan signal line 11 is connected to N second modulation transistors 13B, where N≥2, and the N second modulation transistors 13B are uniformly arranged along the extending direction of the first scan signal line 11.

In an embodiment, the first scan signal line 11 is connected to at least two second modulation transistors 13B. The second modulation transistors 13B are all disposed within the display region AA and are uniformly arranged along the extending direction of the first scan signal line 11.

The uniform arrangement may be understood that connection points of the N second modulation transistors 13B on the first scan signal line 11 substantially divide the signal line into N+1 sub-segments having equal or approximately equal lengths. If the total length of the first scan signal line 11 is L1, the distance between every two adjacent second modulation transistors 13B, and the distances from the first and last second modulation transistors 13B to respective ends of the first scan signal line 11 are all approximately equal.

With this arrangement, multiple equidistant active pull-down or pull-up nodes are formed on the entire first scan signal line 11 so that the pull-up or pull-down effect is uniformly distributed on the length of the entire first scan signal line 11. This can effectively suppress signal attenuation at the various positions, allowing the falling edge or rising edge to remain steep and synchronized along the entire row direction and thereby improving timing accuracy.

In addition, if the second modulation transistors 13B are concentrated in a certain region, the local transistor density is relatively large, which results in a reduced aperture ratio in the region and causes local luminance reduction or color shift, thereby degrading the display uniformity. Therefore, in this embodiment, the second modulation transistors 13B are uniformly arranged along the extending direction of the first scan signal line 11, which can effectively disperse the density of the second modulation transistors 13B, avoid the preceding problem, and improve the full-screen uniform display effect.

FIG. 28 is another diagram illustrating the structure of a display panel according to an embodiment of the present disclosure. As shown in FIG. 28, for example, the display panel further includes a non-display region NAA located on at least one side of the display region AA. The non-display region NAA includes a first non-display region NAA1 located on one side of the display region AA, and the multiple shift register units 12 are located in the first non-display region NAA1. The display region AA includes a first display region AA1 and a second display region AA2, the first display region AA1 and the second display region AA2 are arranged along the extending direction of the first scan signal line 11, and the first display region AA1 is located on one side of the second display region AA2 facing the first non-display region NAA 1. The first scan signal line 11 is connected to N second modulation transistors 13B, where N≥2, and the distribution density of second modulation transistors 13B in the first display region AA1 is smaller than the distribution density of second modulation transistors 13B in the second display region AA2.

In an embodiment, as shown in FIG. 28, the shift register units 12 are disposed within the first non-display region NAA1 on the side of the display region AA and are configured to generate and output the first scan signals scan1.

The display region AA is divided into the first display region AA1 and the second display region AA2. The first display region AA1 is located on one side facing the first non-display region NAA1, serving as a near-end region of the transmission path of the first scan signals scan1. The second display region AA2 is located on one side facing away from the first non-display region NAA1, serving as a far-end region of the transmission path of the first scan signals scan1.

Furthermore, the first scan signal line 11 is connected to at least two second modulation transistors 13B. The second modulation transistors 13B are all disposed within the display region AA, and the distribution density of the second modulation transistors 13B in the first display region AA1 is smaller than the distribution density of the second modulation transistors 13B in the second display region AA2.

The distribution density may be understood as the number of second modulation transistors 13B connected on the per unit length of the first scan signal line 11. For example, within the same length interval, the second display region AA2 is provided with three second modulation transistors 13B, and the first display region AA1 is provided with only two or fewer second modulation transistors 13B.

It is to be understood that, as the first scan signal line 11 transmits the first scan signal scan1 from the first non-display region NAA1 toward the far end, the RC delay accumulates with the distance. As the far-end region, the second display region AA2 experiences a higher degree of signal degradation than the first display region AA1. Therefore, by increasing the distribution density of the second modulation transistors 13B in the far-end region (such as the second display region AA2), a stronger active pull-down or pull-up capability can be provided at a position in which the first scan signal scan1 is severely degraded. Moreover, in the near-end region (such as the first non-display region NAA1), the number of second modulation transistors 13B can be appropriately reduced to lower costs.

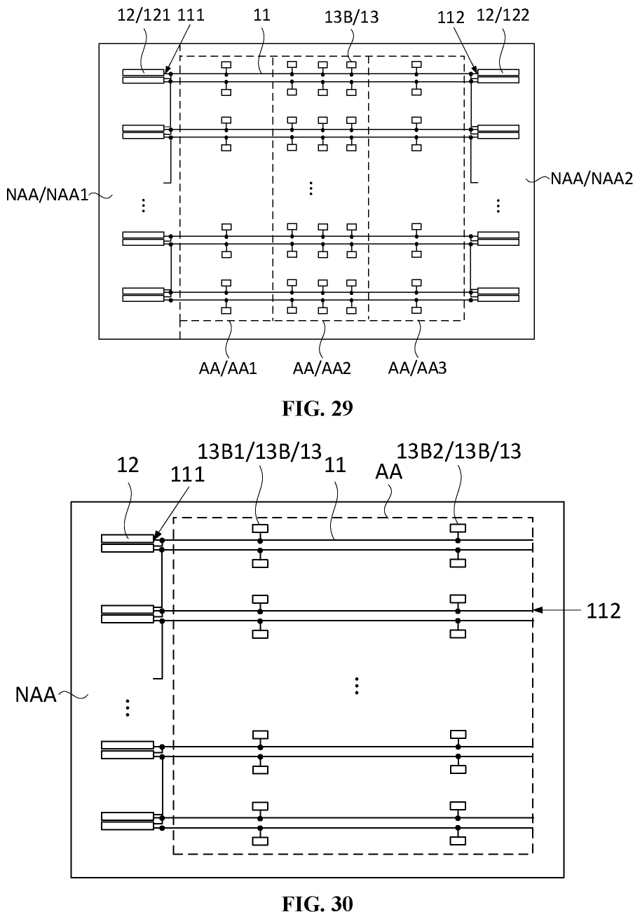

FIG. 29 is another diagram illustrating the structure of a display panel according to an embodiment of the present disclosure. As shown in FIG. 29, for example, the display panel further includes a non-display region NAA located on at least one side of the display region AA. The non-display region NAA includes a first non-display region NAA1 and a second non-display region NAA2 that are located on two opposite sides of the display region AA, respectively. The multiple shift register units 12 include multiple cascaded first shift register units 121 and multiple cascaded second shift register units 122. The multiple first shift register units 121 are located in the first non-display region NAA1, and the multiple second shift register units 122 are located in the second non-display region NAA2. The display region AA includes a first display region AA1, a second display region AA2, and a third display region AA3, the first display region AA1, the second display region AA2, and the third display region AA3 are arranged along the extending direction of the first scan signal line 11, and the second display region AA2 is located between the first display region AA1 and the third display region AA3. The first scan signal line 11 is connected to N second modulation transistors 13B, where N≥2. The distribution density of second modulation transistors 13B in the second display region AA2 is larger than the distribution density of second modulation transistors 13B in the first display region AA1 and the distribution density of second modulation transistors 13B in the third display region AA3.

In an embodiment, as shown in FIG. 29, the non-display region NAA is further divided into the first non-display region NAA1 and the second non-display region NAA2 that are located on the two opposite sides of the display region AA, respectively. The multiple cascaded first shift register units 121 are disposed in the first non-display region NAA1, and the multiple cascaded second shift register units 122 are disposed in the second non-display region NAA2, thereby enabling bidirectional transmission of first scan signals scan1.

It is to be noted that, in this embodiment, as shown in FIG. 29, the display panel employs a dual-sided scan driving manner. That is, a first shift register unit 121 and a second shift register unit 122 synchronously output first scan signals scan1 from the two ends of the first scan signal line 11 (the first end 111 and the second end 112), respectively, to a central region. This dual-sided driving architecture can effectively shorten the transmission distance of a single-sided first scan signal scan1, can alleviate the RC delay effects, and is more suitable for display panels with a large size or high resolution.

Although the dual-sided scan driving has improved the overall integrity of the first scan signal scan1, waveform distortion and degradation may still occur in the central region due to superposition, phase deviation, or load imbalance of the two first scan signals scan1.

In this embodiment, along the extending direction of the first scan signal line 11, the display region AA is divided into the first display region AA1, the second display region AA2, and the third display region AA3, with the first display region AA1 and the third display region AA3 located on two sides of the second display region AA2, respectively. The first scan signal line 11 is connected to at least two second modulation transistors 13B. The distribution density of the second modulation transistors 13B in the second display region AA2 is larger than the distribution density of the second modulation transistors 13B in the first display region AA1 and the distribution density of the second modulation transistors 13B in the third display region AA3.

Increasing the number of second modulation transistors 13B in the central region (that is, the second display region AA2) can provide stronger active pull-down or pull-up capabilities at positions in which the first scan signals scan1 are severely degraded, thereby improving overall display quality. However, the number of second modulation transistors 13B can be appropriately reduced in two side regions (such as the first display region AA1 and the third display region AA3), so as to lower costs.

In other embodiments, a single-sided scan driving manner may also be employed. For example, as shown in FIG. 1, the shift register unit 12 is disposed only in the first non-display region NAA1 to drive the entire first scan signal line 11 from one end. In this case, the degradation degree of the first scan signal scan1 increases monotonically along the first scan signal line 11, and disposing modulation transistors 13 at the far end (that is, a region facing away from the shift register unit 12) can particularly provide compensation for the RC delay of the first scan signal scan1 under single-sided driving. Details are not repeated herein.

In one or more embodiments, as shown in FIGS. 19 to 21, the number of pixel driving circuits 10 that are connected to the first scan signal line 11 is equal to the number of second modulation transistors 13B that are connected to the first scan signal line 11.

In an embodiment, if the first scan signal line 11 is connected to M pixel driving circuits 10, M second modulation transistors 13B are correspondingly connected to the first scan signal line 11, and each second modulation transistor 13B may correspond to or may be adjacent to a respective pixel driving circuit 10 in terms of spatial layout.

For example, in addition to including a driving transistor T3, a first switch transistor T1, and a second switch transistor T2, each pixel driving circuit 10 may further be integrated with a dedicated second modulation transistor 13B.

Since the position of each pixel driving circuit 10 may exhibit a slight delay of the first scan signal scan1 due to differences in parasitic parameters, relying on only a small number of second modulation transistors 13B may be insufficient to achieve high-precision uniform compensation. In this embodiment, by configuring the respective independent second modulation transistor 13B for each pixel driving circuit 10, a pixel-level pull-down or pull-up capability can be achieved, thereby significantly improving regulation accuracy of the first scan signal scan1 at the various positions.

In some embodiments, the second modulation transistor 13B may be used as a component of the pixel driving circuit 10. Employing the existing transistor layout gap of the pixel driving circuit 10 to integrate the second modulation transistor 13B occupies no additional area of another non-light-emitting region, which is beneficial for maintaining a high aperture ratio and improving manufacturing yield.

In one or more embodiments, as shown in FIGS. 3 and 19, the display panel further includes multiple light-emitting elements 20 arranged in an array, and the multiple light-emitting elements 20 are electrically connected to the multiple pixel driving circuits 10. A pixel driving circuit 10 includes a driving transistor T3 and a first switch transistor T1, and the driving transistor T3 and a light-emitting element 20 are connected in series between a first power voltage signal line 31 and a second power voltage signal line 32. A gate of the driving transistor T3 is electrically connected to a first terminal t11 of the first switch transistor T1, a second terminal t12 of the first switch transistor T1 is electrically connected to a data signal line 16, and a gate of the first switch transistor T1 is electrically connected to the first scan signal line 11. The channel width-to-length ratio of a second modulation transistor 13B is less than or equal to the channel width-to-length ratio of the first switch transistor T1.

The specific structures and operating processes of the light-emitting element 20 and the pixel driving circuit 10 can be referred to any of the preceding embodiments and are not repeated herein.

In this embodiment, the second modulation transistor 13B is disposed within the display region AA, and the channel width-to-length ratio of the second modulation transistor 13B is not greater than that of the first switch transistor T1. This can allow the second modulation transistor 13B to have a relatively low static leakage and a relatively small physical size, which can not only reduce overall power consumption but also minimize occupation of the limited space in the display region AA, thereby helping to increase the aperture ratio and improve the manufacturing yield.

FIG. 30 is another diagram illustrating the structure of a display panel according to an embodiment of the present disclosure. As shown in FIG. 30, for example, the first scan signal line 11 is connected to at least two second modulation transistors 13B. At least two second modulation transistors 13B connected to the same first scan signal line 11 include a second near-end modulation transistor 13B1 and a second far-end modulation transistor 13B2. The distance between the second near-end modulation transistor 13B1 and a shift register unit 12 is smaller than the distance between the second far-end modulation transistor 13B2 and the shift register unit 12. The channel width-to-length ratio of the second near-end modulation transistor 13B1 is smaller than the channel width-to-length ratio of the second far-end modulation transistor 13B2.

In an embodiment, the first scan signal line 11 is connected to the at least two second modulation transistors 13B, and any two second modulation transistors 13B may be designated as the second near-end modulation transistor 13B1 closer to the shift register unit 12 and the second far-end modulation transistor 13B2 farther from the shift register unit 12.

The second near-end modulation transistor 13B1 is close to the shift register unit 12, where the integrity of the first scan signal scan1 is relatively good. Therefore, the second near-end modulation transistor 13B1 has a relatively small channel width-to-length ratio, which can reduce the power consumption and minimize the occupation of the limited space in the display region AA, thereby helping to increase the aperture ratio and improve the manufacturing yield.

The second far-end modulation transistor 13B2 is located on one side on which the transmission path of the first scan signal scan1 is exceedingly long. Due to the RC delay effects, the waveform of the first scan signal scan1 is severely degraded. By increasing the channel width-to-length ratio of the second far-end modulation transistor 13B2, a stronger active pull-down or pull-up capability can be provided, thereby rapidly pulling the voltage of the first scan signal line 11 to the modulation voltage and ensuring that a first switch transistor T1 at the position can be turned off timely.

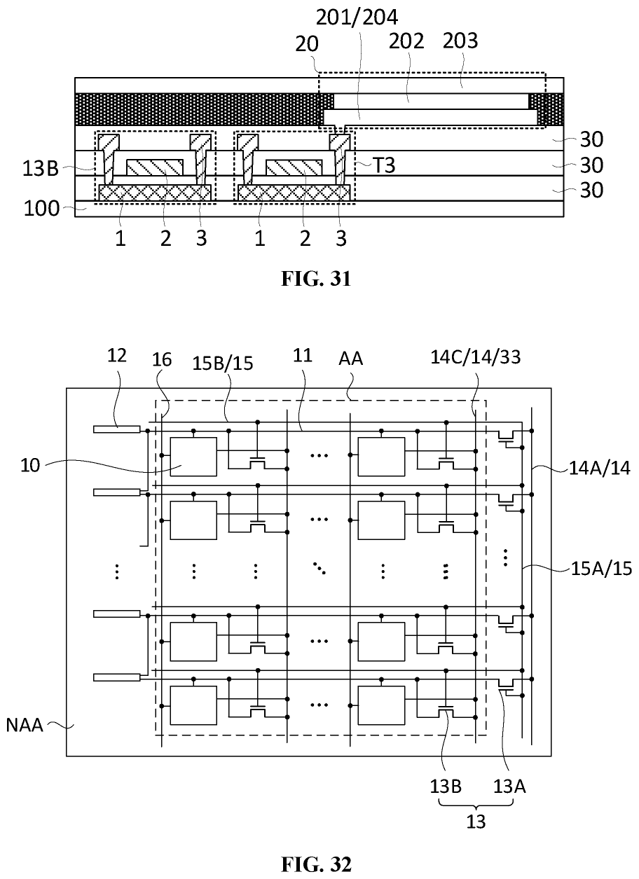

FIG. 31 is a partial cross-sectional diagram of a display panel according to an embodiment of the present disclosure. As shown in FIG. 31, for example, the display panel further includes a base substrate 100 and multiple light-emitting elements 20 located on one side of the base substrate 100, and driving electrodes 204 of the multiple light-emitting elements 20 are electrically connected to the multiple pixel driving circuits 10. Vertical projections of the multiple second modulation transistors 13B on the base substrate 100 do not overlap vertical projections of the driving electrodes 204 of the multiple light-emitting elements 20 on the base substrate 100.

In an embodiment, each light-emitting element 20 includes a driving electrode 204, and the driving electrode 204 refers to an electrode used to provide a driving current to the light-emitting element 20. The driving electrodes 204 are electrically connected to the pixel driving circuits 10 located on the base substrate 100 and can receive driving currents output by driving transistors T3, thereby controlling the brightness of the light-emitting elements 20.

The configuration of the driving electrode 204 specifically depends on the device structure of the light-emitting element 20. For example, when the light-emitting element 20 is an organic light-emitting diode (OLED), the driving electrode 204 is an anode 201 of the light-emitting element 20. When the light-emitting element 20 is a micro light-emitting diode (MicroLED), the driving electrode 204 may be a p electrode of the light-emitting element 20. The configuration of the driving electrode 204 is not limited herein.

Furthermore, with the multiple second modulation transistors 13B located within the display region AA, the vertical projections of the multiple second modulation transistors 13B on the base substrate 100 do not overlap the vertical projections of the driving electrodes 204 of the multiple light-emitting elements 20 on the base substrate 100. For a second modulation transistor 13B, an active layer 1, a gate 2, source and drain electrodes 3, and other components completely avoid a region occupied by the driving electrode 204 on the plane, ensuring that the second modulation transistor 13B and the driving electrode 204 do not overlap in spatial layout.

With this arrangement, the second modulation transistor 13B can be prevented from interfering with the potential of the driving electrode 204 due to a parasitic capacitor, so as to avoid fluctuations or flickering in the brightness, thereby improving display stability.

Moreover, by avoiding disposing the second modulation transistor 13B below the driving electrode 204, the flatness of layers below the driving electrode 204 can be improved, reducing the risk of short circuits or open circuits caused by poor step coverage during the manufacturing of the driving electrode 204 and thereby improving manufacturing yield.

FIG. 32 is another diagram illustrating the structure of a display panel according to an embodiment of the present disclosure. As shown in FIG. 32, for example, the display panel further includes a display region AA and a non-display region NAA located on at least one side of the display region AA. The multiple modulation transistors 13 include multiple first modulation transistors 13A and multiple second modulation transistors 13B. The multiple first modulation transistors 13A are located within the non-display region NAA, and the multiple second modulation transistors 13B are located within the display region AA. The channel width-to-length ratio of a first modulation transistor 13A is greater than or equal to the channel width-to-length ratio of a second modulation transistor 13B.

In an embodiment, as shown in FIG. 32, the first modulation transistors 13A are disposed in the non-display region NAA, while the second modulation transistors 13B are disposed in the display region AA, which can enhance the response speed and consistency of the pixel driving circuits 10 in different regions, improve the consistency of charging times, and thereby improve the display uniformity.

Since the wiring space in the non-display region NAA is relatively ample and can accommodate transistors with a relatively large size, the first modulation transistor 13A is configured with a relatively large channel width-to-length ratio, so as to provide a stronger pull-down or pull-up driving capability, thereby effectively addressing the signal delay.

Moreover, constrained by the high-density pixel layout and aperture ratio requirements within the display region AA, the second modulation transistor 13B is configured with a relatively small channel width-to-length ratio, so as to reduce the size of the second modulation transistor 13B, minimize obstruction of the second modulation transistor 13B on a light-emitting region, ensure a relatively high aperture ratio, and also help reduce static power consumption and parasitic capacitors, thereby improving overall circuit efficiency.

In some embodiments, as shown in FIG. 32, the first modulation transistor 13A and the second modulation transistor 13B may be connected to different modulation voltage signal lines 14. For example, the first modulation transistor 13A is connected to the first modulation voltage signal line 14A, and the first modulation voltage signal line 14A is electrically connected to the first voltage signal line 17. The second modulation transistor 13B is connected to the third modulation voltage signal line 14C, and the third modulation voltage signal line 14C is the same signal line as the reference voltage signal line 33. In this manner, the wiring path can be short to facilitate a low-impedance and highly reliable connection. However, this configuration is not limited herein.

In some embodiments, the first modulation transistor 13A and the second modulation transistor 13B may also be connected to the same modulation voltage signal line 14. In this case, the first modulation transistor 13A and the second modulation transistor 13B are electrically connected to the same physical wiring, which can ensure consistency of the modulation voltage signal and avoid non-uniform turn-off delays caused by multi-power level drift or timing misalignment, thereby helping to improve the display uniformity.

In some embodiments, as shown in FIG. 32, the first modulation transistor 13A and the second modulation transistor 13B may be connected to different modulation control signal lines 15. For example, the first modulation transistor 13A is connected to the first modulation control signal line 15A, and the first modulation control signal line 15A is electrically connected to the first clock signal line 35 or the second clock signal line 36; the second modulation transistor 13B is connected to the second modulation control signal line 15B, and the extending direction of the second modulation control signal line 15B is the same as that of the first scan signal line 11. In this manner, the wiring path can be short to facilitate the low-impedance and highly reliable connection. However, this configuration is not limited herein.

In some embodiments, the first modulation transistor 13A and the second modulation transistor 13B may also be connected to the same modulation control signal line 15. In this case, the first modulation transistor 13A and the second modulation transistor 13B are electrically connected to the same physical wiring, so as to share the same modulation control signal source and wiring path. This configuration can eliminate potential problems such as clock skew or non-uniform driving capability among multiple modulation control signals, enabling synchronized pull-up or pull-down operations and thereby helping to improve the display uniformity.

In some embodiments, as shown in FIG. 1, the modulation transistors 13 may include only the first modulation transistors 13A, that is, the display panel has the first modulation transistors 13A disposed only in the non-display region NAA.

In some embodiments, as shown in FIG. 19, the modulation transistors 13 may include only the second modulation transistors 13B, that is, the display panel has the second modulation transistors 13B disposed only in the display region AA. This is not specifically limited in the embodiment of the present disclosure.

In some embodiments, the modulation transistors 13 may include the first modulation transistors 13A and the second modulation transistors 13B. That is, the display panel has the first modulation transistors 13A disposed in the non-display region NAA and the second modulation transistors 13B disposed in the display region AA. The appropriate configuration can be selected according to specific application requirements.

In one or more embodiments, as shown in FIGS. 1 and 3, the multiple modulation transistors 13 and transistors in the multiple pixel driving circuits 10 are all n-type transistors or p-type transistors.

In an embodiment, the modulation transistors 13 and the transistors in the pixel driving circuits 10 (including, but not limited to, driving transistors T3, first switch transistors T1, and second switch transistors T2) are of the same transistor type, that is, all are the n-type transistors or the p-type transistors. With this arrangement, the modulation transistors 13 and the transistors in the pixel driving circuits 10 can be prepared using the same preparation process, which can simplify the process steps and lower manufacturing costs. Moreover, transistors of the same type exhibit the consistent trend under process variations (such as non-uniform film thickness or changes in the interface state density), which can reduce electrical parameter dispersion between sub-pixels or modulation points, thereby improving the display uniformity and long-term operational stability.

In some embodiments, as shown in FIGS. 1 and 3, the modulation transistors 13 and the transistors in the pixel driving circuits 10 are all the n-type transistors, for example, indium gallium zinc oxide (IGZO) transistors, which offer advantages such as a small leakage current.

In some embodiments, the modulation transistors 13 and the transistors in the pixel driving circuits 10 are all the p-type transistors, for example, low-temperature polycrystalline silicon (LTPS) transistors, which offer advantages such as a high switching speed, a high carrier mobility, and a low power consumption.

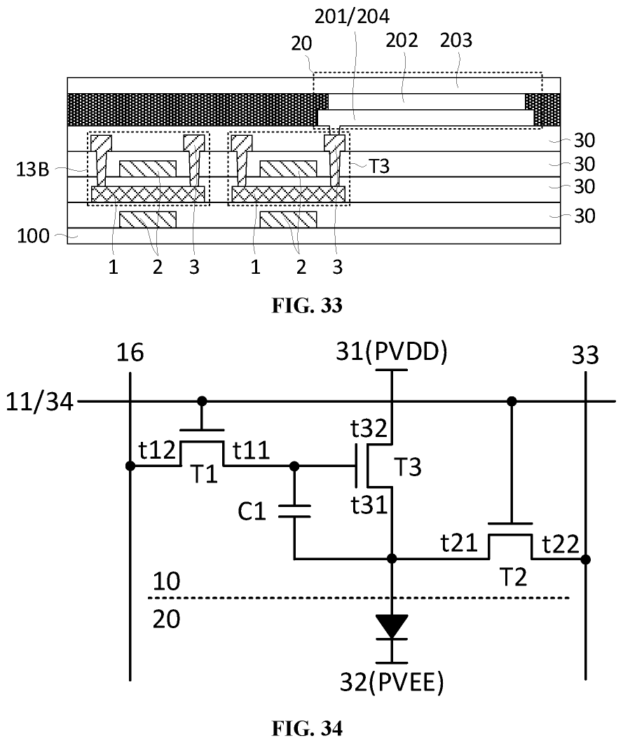

FIG. 33 is a partial cross-sectional diagram of a display panel according to an embodiment of the present disclosure. As shown in FIG. 33, for example, the display panel further includes multiple light-emitting elements 20 arranged in an array, and the multiple light-emitting elements 20 are electrically connected to the multiple pixel driving circuits 10. A pixel driving circuit 10 includes a driving transistor T3, and the driving transistor T3 and a light-emitting element 20 are connected in series between a first power voltage signal line 31 and a second power voltage signal line 32. At least one of the modulation transistor 13 or the driving transistor T3 is a double-gate transistor.

The specific structures and operating processes of the light-emitting element 20 and the pixel driving circuit 10 can be referred to any of the preceding embodiments and are not repeated herein.

In this embodiment, the at least one of the modulation transistor 13 or the driving transistor T3 is the double-gate transistor. The double-gate transistor refers to a thin-film transistor with a gate structure that has two independent or common electrodes. For the double-gate transistor, an active layer 1 is sandwiched between an upper gate 2 and a lower gate 2 (top-gate and bottom-gate structure, as shown in FIG. 33), or two parallel/series-connected gates are arranged on the same side (such as segmented gates), which can reduce a leakage current of the transistor.

In some embodiments, the driving transistor T3 has the double-gate structure. By applying identical or complementary bias voltages to the upper and lower gates, the drain-induced barrier lowering (DIBL) effect and an off-state leakage current (Ioff) can be effectively suppressed, thereby improving current driving stability and helping to maintain brightness consistency.

In some embodiments, the modulation transistor 13 has the double-gate structure, which can enhance the blocking capability of the modulation transistor 13 in an off state and prevent unintended pull-down or pull-up caused by the first scan signal line 11 being floating during a non-modulation period. Moreover, in an on state, the double-gate structure can cooperatively enhance the transconductance, thereby providing a stronger pull-down or pull-up capability and improving the waveform of the first scan signal scan1 on the first scan signal line 11.

It is to be noted that, as shown in FIG. 19, the display panel employs a single gate line driving (SGLD) architecture. A core feature of this architecture is that each column of pixel driving circuits 10 exclusively shares one data signal line 16, and each row of pixel driving circuits 10 is controlled by only one first scan signal line 11.

However, through research, the inventors have found that when the SGLD architecture is applied to higher-resolution and larger-sized applications (such as large-sized OLED TVs), the number of data signal lines 16 increases significantly, resulting in a large required number of source IC channels. As a result, the chip cost, packaging cost, and the difficulty and cost of bonding the source IC channels to the display panel are all substantially increased. Moreover, a large number of data signal lines 16 require a larger wiring space in a fan-out region at the edge of the display panel, which severely constrains the narrow-bezel design of the lower bezel (or the upper bezel) of the display panel. It is to be understood that, as the resolution increases and the pixel density becomes larger, the number of data signal lines 16 further increases, thereby exacerbating the preceding cost and bezel-related problems.

Based on the preceding technical problems, for example, as shown in FIGS. 1 to 18, the multiple pixel driving circuits 10 arranged in an array further include multiple pixel driving circuit rows 101 arranged in the column direction Y. A pixel driving circuit row 101 includes multiple pixel driving circuit groups 1011 arranged in the row direction X. A pixel driving circuit group 1011 includes two adjacent pixel driving circuits 10 along the row direction X, which are referred to as a first pixel driving circuit 10A and a second pixel driving circuit 10B. In the same pixel driving circuit group 1011, a first pixel driving circuit 10A and a second pixel driving circuit 10B are connected to the same data signal line 16 and to different first scan signal lines 11.

As shown in FIGS. 1 to 18, this embodiment employs a dual gate line driving (DGLD) architecture. A core feature of this architecture is that, in the same pixel driving circuit group 1011, the first pixel driving circuit 10A and the second pixel driving circuit 10B share the same data signal line 16 but are connected to two different first scan signal lines 11, respectively.

Furthermore, the data signal line 16 extends along the column direction Y and provides a data signal to the same column of multiple pixel driving circuit groups 1011.

The two first scan signal lines 11 extend along the row direction X. In the same pixel driving circuit group 1011, the first pixel driving circuit 10A and the second pixel driving circuit 10B are controlled by the two independent first scan signal lines 11, respectively (for example, an n-th row first scan signal line 11 controls the first pixel driving circuit 10A, and an (n+1)-th first scan signal line 11 controls the second pixel driving circuit 10B).

In the row direction X, one data signal line 16 is arranged for every two pixel driving circuits 10; in the column direction Y, each row of pixel driving circuits 10 corresponds to two respective independent first scan signal lines 11. This arrangement can reduce the number of data signal lines 16 to half of that in a conventional RGB arrangement (each column of pixel driving circuits 10 corresponds to one respective data signal line 16).

With this arrangement, in the same frame cycle, a first scan signal scan1 controlling the first pixel driving circuit 10A and a first scan signal scan1 controlling the second pixel driving circuit 10B have their turn-on voltages V11 staggered in time.

When the first scan signal scan1 controlling the first pixel driving circuit 10A is at a turn-on voltage V11, a first switch transistor T1 of the first pixel driving circuit 10A is turned on. In this case, a data signal DATA corresponding to the first pixel driving circuit 10A is transmitted on the data signal line 16 and is written into a gate of a driving transistor T3 of the first pixel driving circuit 10A.

Subsequently, when the first scan signal scan1 controlling the first pixel driving circuit 10A is at a turn-off voltage V12, and the first scan signal scan1 controlling the second pixel driving circuit 10B is at a turn-on voltage V11, a first switch transistor T1 of the second pixel driving circuit 10B is turned on. In this case, a data signal DATA corresponding to the second pixel driving circuit 10B is transmitted on the data signal line 16 and is written into a gate of a driving transistor T3 of the second pixel driving circuit 10B.

Therefore, the same data signal line 16, through time-division reusing, sequentially writes the data signals DATA into the first pixel driving circuit 10A and the second pixel driving circuit 10B within the same pixel driving circuit group 1011.

In this embodiment, since two columns of pixel driving circuits 10 share one data signal line 16, the total number of data signal lines 16 required for the entire display panel can be reduced by nearly 50%. In this manner, the required number of source IC channels can be halved, thereby substantially lowering the chip cost, packaging cost, and the difficulty and cost of bonding the source IC channels to the display panel. Moreover, the wiring space required for the data signal line 16 in the lead-out region can be reduced, which can help to narrow the width of the lower bezel and achieve the narrow-bezel design.

It is to be noted that, through further research, the inventors have found that the DGLD architecture requires two data signal writes to be completed through the time-division reusing within a single row scan period (1H) (for example, the first pixel driving circuit 10A and the second pixel driving circuit 10B in the same pixel driving circuit group 1011 need to be written with the data signals respectively). As a result, each first scan signal line 11 is required to switch the first scan signal scan1 between the turn-on voltage V11 and the turn-off voltage V12 more rapidly and accurately.

In an embodiment, if the falling edge of a first scan signal scan1 controlling a certain row of pixel driving circuits 10 is slowed, first switch transistors T1 corresponding to the row of pixel driving circuits 10 cannot be turned off completely in time, and when a data signal on a data signal line 16 switches to a data signal for the next row, the first switch transistors T1 of the current row that have not been completely turned off erroneously have the data signal for the next row written into the current row of pixel driving circuits 10, resulting in severe data crosstalk. In the DGLD architecture, since the two columns of pixel driving circuits 10 share the one data signal line 16, the possibility of data crosstalk is significantly increased.

Therefore, rising-edge/falling-edge delay or waveform degradation of a first scan signal scan1 on any first scan signal line 11 affects the data signal writing of the current row of pixel driving circuits 10 and may further, via the shared data signal line 16, directly interfere with the accurate data signal writing of adjacent rows/columns of pixel driving circuits 10, thereby resulting in complex display abnormalities.

Moreover, the requirements for high resolution and high refresh rates continuously compress the row scan period (1H). Under the DGLD architecture, it is therefore necessary to further shorten the duration of the switching stage T0 between the turn-on voltage V11 and the turn-off voltage V12 of the first scan signal scan1, so as to provide a more sufficient effective time window for two data signal writes of the same row of pixel driving circuits 10 and to ensure that within the limited row scan period (1H), each pixel driving circuit 10 can obtain sufficient charging time.

It is to be noted that the solution of disposing the modulation transistor 13 in the preceding embodiment of the present disclosure can effectively address the preceding requirements faced by the DGLD architecture. In an embodiment, by configuring a respective modulation transistor 13 for each first scan signal line 11, strong active pull-down or pull-up can be provided in the switching stage T0 in which the first scan signal scan1 needs to switch from the turn-on voltage V11 to the turn-off voltage V12, thereby accelerating the switching of the first scan signal scan1 and significantly shortening the duration of the switching stage T0. As a result, the time window during which the first switch transistors T1 are not completely turned off can be reduced, the possibility of data crosstalk can be lowered, and the accuracy of a data signal written into pixel driving circuits 10 can be ensured. In this manner, while cost reduction is achieved through the DGLD architecture, clearer data signal writing boundaries can be obtained, the risk of data crosstalk can be eliminated, and the impact on the display quality can be reduced, thereby facilitating the stable application of the DGLD architecture in high-performance and high-resolution display products.

In one or more embodiments, as shown in FIG. 3, the display panel further includes multiple light-emitting elements 20 arranged in an array, and the multiple light-emitting elements 20 are electrically connected to the multiple pixel driving circuits 10. A pixel driving circuit 10 includes a driving transistor T3, a first switch transistor T1, and a second switch transistor T2, and the driving transistor T3 and a light-emitting element 20 are connected in series between a first power voltage signal line 31 and a second power voltage signal line 32. A gate of the driving transistor T3 is electrically connected to a first terminal t11 of the first switch transistor T1, a second terminal t12 of the first switch transistor T1 is electrically connected to a data signal line 16, and a gate of the first switch transistor T1 is electrically connected to the first scan signal line 11. A first terminal t21 of the second switch transistor T2 is electrically connected to a first terminal t31 of the driving transistor T3, a second terminal t22 of the second switch transistor T2 is electrically connected to a reference voltage signal line 33, and a gate of the second switch transistor T2 is electrically connected to a second scan signal line 34. The first scan signal line 11 is the same line as or a different line from the second scan signal line 34.

The specific structures of the light-emitting element 20 and the pixel driving circuit 10 can be referred to any of the preceding embodiments and are not repeated herein.

In some embodiments, as shown in FIGS. 3 and 14, the first scan signal line 11 may be a different line from the second scan signal line 34, and their operating processes can be referred to the preceding embodiments and are not repeated herein.

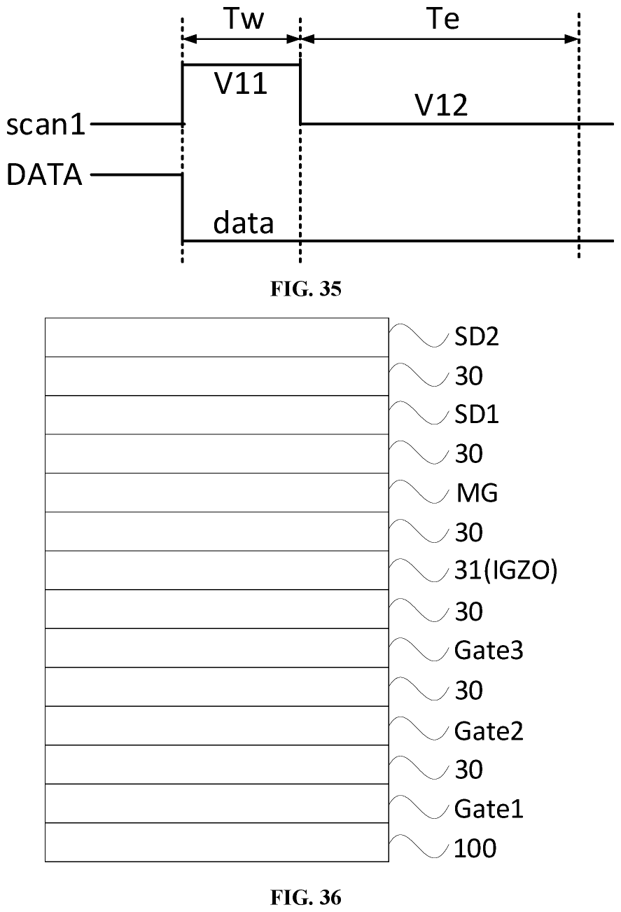

FIG. 34 is another diagram illustrating the structure of a pixel driving circuit according to an embodiment of the present disclosure. FIG. 35 is another operating timing diagram of a pixel driving circuit according to an embodiment of the present disclosure. As shown in FIGS. 34 and 35, for example, the first scan signal line 11 is the same signal line as the second scan signal line 34. In this case, the operating cycle of the pixel driving circuit 10 may include a data writing stage Tw and the light-emitting stage Te.

In the data writing stage Tw, the first scan signal scan1 provided by the first scan signal line 11 is maintained at the turn-on voltage V11, and the first switch transistor T1 is turned on in response to the turn-on voltage V11, so as to apply the data voltage (data) of the data signal DATA on the data signal line 16 to the gate of the driving transistor T3. The second switch transistor T2 is turned on in response to the turn-on voltage V11, so as to apply the reference voltage vref of the reference voltage signal VREF on the reference voltage signal line 33 to the first terminal t31 of the driving transistor T3.

In the light-emitting stage Te, the first scan signal scan1 provided by the first scan signal line 11 is maintained at the turn-off voltage V12 so that the first switch transistor T1 and the second switch transistor T2 are turned off. The first power voltage PVDD charges a source of the driving transistor T3 through the driving transistor T3, causing the source voltage to gradually rise. Due to the coupling effect of the first capacitor C1, the gate voltage of the driving transistor T3 is also raised accordingly, and the gate-source voltage of the driving transistor T3 is substantially maintained at the voltage value (data-vref) stored in the data writing stage Tw. When the source voltage rises above the operating point voltage of the light-emitting element 20, the driving current flows through the light-emitting element 20, driving the light-emitting element 20 to emit light. The magnitude of the driving current is determined by the gate-source voltage of the driving transistor T3, thereby achieving the desired grayscale display.

In this embodiment, by combining the first scan signal line 11 and the second scan signal line 34 into the same signal line, the wiring of one scan signal line is reduced, which can lower the complexity of the layout, help increase the aperture ratio, and reduce coupling capacitors among signal lines, thereby contributing to improved display uniformity.

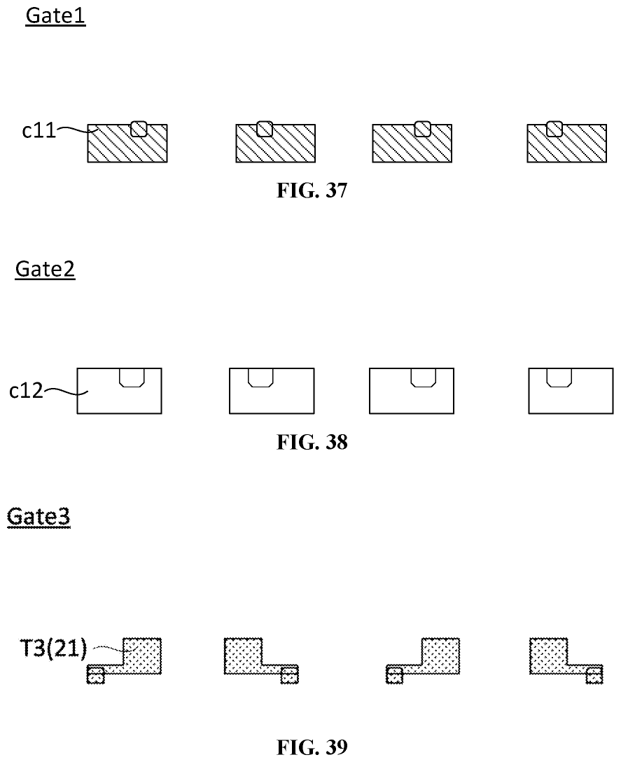

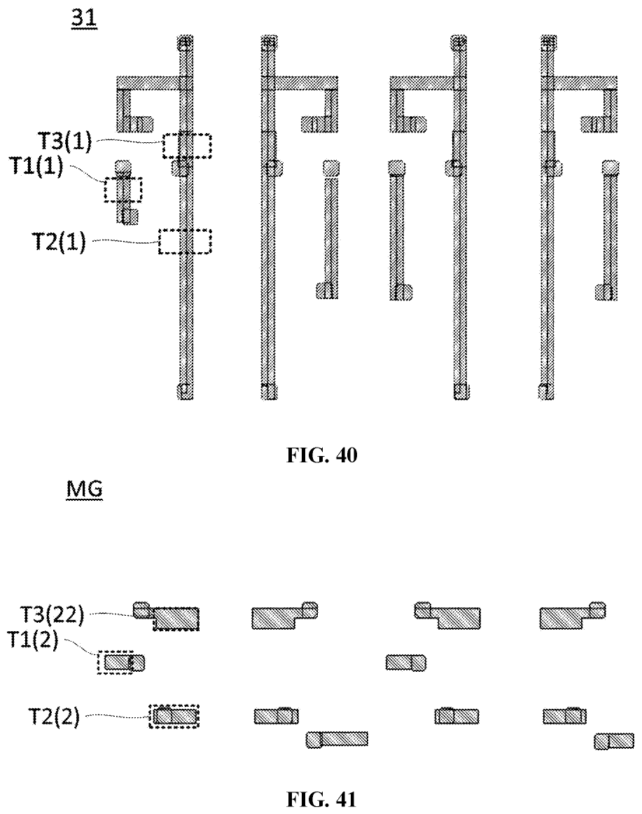

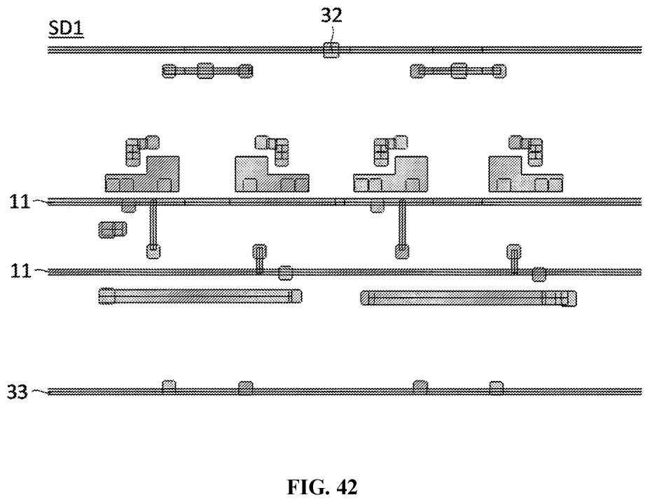

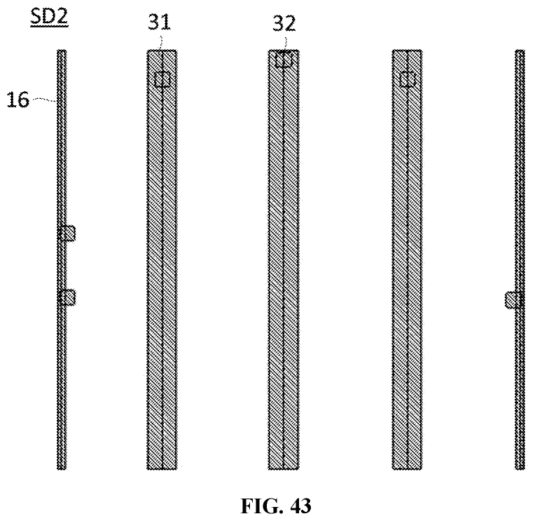

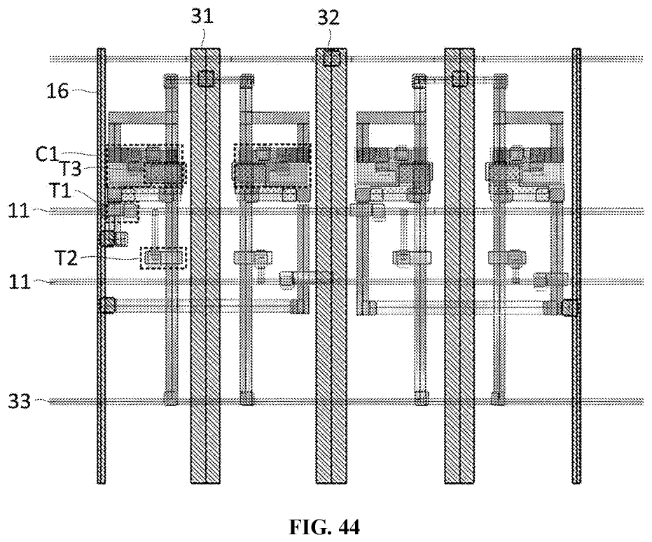

FIG. 36 is a diagram illustrating the structure of films of a pixel driving circuit in a display panel according to an embodiment of the present disclosure. FIG. 37 is a diagram illustrating the structure of a first metal layer in the pixel driving circuit shown in FIG. 36. FIG. 38 is a diagram illustrating the structure of a second metal layer in the pixel driving circuit shown in FIG. 36. FIG. 39 is a diagram illustrating the structure of a third metal layer in the pixel driving circuit shown in FIG. 36. FIG. 40 is a diagram illustrating the structure of a semiconductor layer in the pixel driving circuit shown in FIG. 36. FIG. 41 is a diagram illustrating the structure of a fourth metal layer in the pixel driving circuit shown in FIG. 36. FIG. 42 is a diagram illustrating the structure of a fifth metal layer in the pixel driving circuit shown in FIG. 36. FIG. 43 is a diagram illustrating the structure of a sixth metal layer in the pixel driving circuit shown in FIG. 36. FIG. 44 is a diagram illustrating the stacked structure of films in the pixel driving circuit shown in FIG. 36. As shown in FIGS. 36 to 44, for example, a first metal layer Gate1, a second metal layer Gate2, a third metal layer Gate3, a semiconductor layer 31, a fourth metal layer MG, a fifth metal layer SD1, and a sixth metal layer SD2 are sequentially stacked on one side of the base substrate 100. As shown in FIGS. 2, 31, 33, and 36, an insulating layer 30 may be provided between any two adjacent conductive films to prevent a short circuit between the any two adjacent conductive films.

It is to be noted that the structure of the films shown in FIGS. 36 to 44 can correspond to the pixel driving circuit 10 shown in FIG. 34, in which the first switch transistor T1, the second switch transistor T2, and the driving transistor T3 are all indium gallium zinc oxide (IGZO) transistors, which is not limited herein.

In one or more embodiments, as shown in FIGS. 37 to 44, a first plate c11 of the first capacitor C1 is located in the first metal layer Gate1, and a second plate c12 of the first capacitor C1 is located in the second metal layer Gate2.

A bottom gate 21 of the driving transistor T3 is located in the third metal layer Gate3.

Active layers of the first switch transistor T1, the second switch transistor T2, and the driving transistor T3 are located in the semiconductor layer 31. The semiconductor layer 31 may be made of indium gallium zinc oxide (IGZO), which is not limited herein.

A top gate 22 of the driving transistor T3, the gate 2 of the first switch transistor T1, and the gate 2 of the second switch transistor T2 are located in the fourth metal layer MG.

The first scan signal line 11 extending along the row direction, lateral auxiliary lines of the second power voltage signal line 32, and lateral auxiliary lines of the reference voltage signal line 33 are located in the fifth metal layer SD1.

The data signal line 16 extending along the column direction, the first power voltage signal line 31, and the second power voltage signal line 32 are located in the sixth metal layer SD2.

It is to be noted that, for the specific film arrangement of the display panel, adaptive adjustments may be made according to the actual requirements such as adding or subtracting some films, which is not specifically limited in the embodiment of the present disclosure.

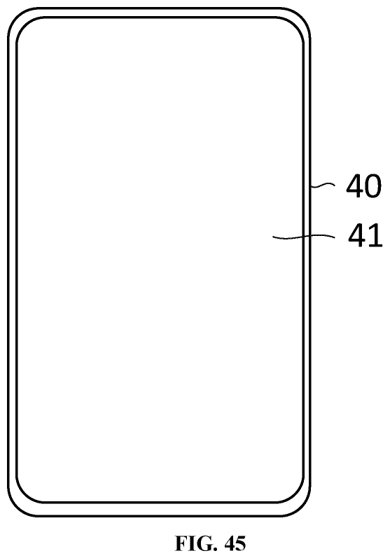

Based on the same inventive concept, an embodiment of the present disclosure further provides a display device. FIG. 45 is a diagram illustrating the structure of a display device according to an embodiment of the present disclosure. As shown in FIG. 45, the display device 40 includes the display panel 41 according to any embodiment of the present disclosure. Therefore, the display device 40 provided in the embodiment of the present disclosure has the technical effects of the technical solutions according to any preceding embodiment, and structures that are the same as or correspond to the structures in the preceding embodiments and the explanation of the terms are not repeated herein.

The display device 40 provided in the embodiment of the present disclosure may be a cellphone shown in FIG. 45 or may be any other electronic product having a display function. The electronic product includes, but is not limited to, a television, a laptop, a desktop display, a tablet, a digital camera, a smart bracelet, smart glasses, an in-vehicle display, a medical device, an industrial control device, or an interactive touch terminal. The display device 40 is not specially limited in the embodiment of the present disclosure.

It is to be understood that various forms of processes shown in the preceding may be adopted with steps reordered, added, or deleted. For example, the steps described in the present disclosure may be performed in parallel, sequentially, or in different sequences, as long as the desired results of the technical solutions of the present disclosure can be achieved, and no limitation is imposed herein.

The preceding embodiments do not limit the scope of the present disclosure. It is to be understood by those skilled in the art that various modifications, combinations, sub-combinations, and substitutions can be made according to design requirements and other factors. Any modifications, equivalent substitutions, or improvements that are made within the spirit and principle of the present disclosure are within the scope of the present disclosure.

What is claimed is:

1. A display panel, comprising:
a plurality of pixel driving circuits arranged in an array;
a plurality of first scan signal lines, wherein the plurality of first scan signal lines are electrically connected to the plurality of pixel driving circuits and are configured to provide first scan signals to the plurality of pixel driving circuits;
a plurality of shift register units, wherein the plurality of shift register units are cascaded, are correspondingly electrically connected to the plurality of first scan signal lines, and are configured to output the first scan signals to the plurality of first scan signal lines, wherein voltages of a first scan signal of the first scan signals comprise a turn-on voltage and a turn-off voltage;
a plurality of modulation transistors, wherein a first terminal of a modulation transistor of the plurality of modulation transistors is electrically connected to a first scan signal line of the plurality of first scan signal lines;
a plurality of modulation voltage signal lines, wherein a modulation voltage signal line of the plurality of modulation voltage signal lines is electrically connected to a second terminal of the modulation transistor and is configured to provide a modulation voltage to the second terminal of the modulation transistor; and
a plurality of modulation control signal lines, wherein a modulation control signal line of the plurality of modulation control signal lines is electrically connected to a gate of the modulation transistor and is configured to provide a modulation control signal to the gate of the modulation transistor, and the modulation control signal comprises a valid pulse, and the valid pulse is configured to control the modulation transistor to turn on,
wherein a switching stage between the turn-on voltage of the first scan signal and the turn-off voltage of the first scan signal overlaps the valid pulse of the modulation control signal.

2. The display panel according to claim 1, wherein the turn-on voltage is higher than the turn-off voltage, and the modulation voltage is lower than the turn-on voltage; or
the turn-on voltage is lower than the turn-off voltage, and the modulation voltage is higher than the turn-on voltage.

3. The display panel according to claim 1, wherein
the display panel further comprises a first voltage signal line and a second voltage signal line;
a shift register unit of the plurality of shift register units comprises a first transistor and a second transistor;
a first terminal of the first transistor is electrically connected to the first voltage signal line, a second terminal of the first transistor is electrically connected to the first scan signal line, and the first transistor is configured to provide a first voltage on the first voltage signal line to the first scan signal line;
a first terminal of the second transistor is electrically connected to the second voltage signal line, a second terminal of the second transistor is electrically connected to the first scan signal line, and the second transistor is configured to provide a second voltage on the second voltage signal line to the first scan signal line;
the first voltage is higher than the second voltage;
the plurality of modulation voltage signal lines comprise a first modulation voltage signal line; and
the first modulation voltage signal line is electrically connected to the first voltage signal line, and the modulation voltage is the same as the first voltage; or the first modulation voltage signal line is electrically connected to the second voltage signal line, and the modulation voltage is the same as the second voltage.

4. The display panel according to claim 1, wherein the display panel further comprises a plurality of light-emitting elements arranged in an array, and the plurality of light-emitting elements are electrically connected to the plurality of pixel driving circuits;
the display panel further comprises a plurality of first power voltage signal lines and a plurality of second power voltage signal lines;
a pixel driving circuit of the plurality of pixel driving circuits comprises a driving transistor, and the driving transistor and a light-emitting element of the plurality of light-emitting elements are connected in series between a first power voltage signal line of the plurality of first power voltage signal lines and a second power voltage signal line of the plurality of second power voltage signal lines;
a first power voltage transmitted by the first power voltage signal line is higher than a second power voltage transmitted by the second power voltage signal line;
the plurality of modulation voltage signal lines comprise a second modulation voltage signal line; and
the second modulation voltage signal line is a same signal line as the first power voltage signal line, and the modulation voltage is the same as the first power voltage;
or the second modulation voltage signal line is a same signal line as the second power voltage signal line, and the modulation voltage is the same as the second power voltage.

5. The display panel according to claim 1, further comprising a plurality of light-emitting elements arranged in an array, wherein the plurality of light-emitting elements are electrically connected to the plurality of pixel driving circuits;
a pixel driving circuit of the plurality of pixel driving circuits comprises a driving transistor, a first switch transistor, and a second switch transistor, and the driving transistor and a light-emitting element of the plurality of light-emitting elements are connected in series between a first power voltage signal line of a plurality of first power voltage signal lines and a second power voltage signal line of a plurality of second power voltage signal lines;
a gate of the driving transistor is electrically connected to a first terminal of the first switch transistor, a second terminal of the first switch transistor is electrically connected to a data signal line of a plurality of data signal lines, and a gate of the first switch transistor is electrically connected to the first scan signal line;
a first terminal of the second switch transistor is electrically connected to a first terminal of the driving transistor, a second terminal of the second switch transistor is electrically connected to a reference voltage signal line of a plurality of reference voltage signal lines, and a gate of the second switch transistor is electrically connected to a second scan signal line of a plurality of second scan signal lines; and
the plurality of modulation voltage signal lines comprise a plurality of third modulation voltage signal lines, and a third modulation voltage signal line of the plurality of third modulation voltage signal lines is a same signal line as the reference voltage signal line to provide the modulation voltage to the modulation transistor via the reference voltage signal line.

6. The display panel according to claim 5, wherein the pixel driving circuit has a light-emitting stage in which the first switch transistor and the second switch transistor are turned off;
in a conduction stage of the second switch transistor, a reference voltage is transmitted on the reference voltage signal line;
in the light-emitting stage, the modulation voltage is transmitted on the reference voltage signal line; and
the reference voltage is different from the modulation voltage.

7. The display panel according to claim 1, wherein the display panel further comprises a first clock signal line and a second clock signal line;
the first clock signal line is electrically connected to the plurality of shift register units and is configured to provide a first clock signal to the plurality of shift register units;
the second clock signal line is electrically connected to the plurality of shift register units and is configured to provide a second clock signal to the plurality of shift register units;
the first clock signal and the second clock signal are inverted with respect to each other;
the plurality of modulation control signal lines comprise a first modulation control signal line; and
the first modulation control signal line is electrically connected to the first clock signal line, and the modulation control signal is same as the first clock signal; or the first modulation control signal line is electrically connected to the second clock signal line, and the modulation control signal is same as the second clock signal.

8. The display panel according to claim 1, comprising a display region, wherein the plurality of modulation control signal lines further comprise a plurality of second modulation control signal lines at least partially located in the display region; and
wherein an extending direction of the plurality of second modulation control signal lines is the same as an extending direction of the plurality of first scan signal lines.

9. The display panel according to claim 8, further comprising a plurality of modulation control signal generation units, wherein an input terminal of a modulation control signal generation unit of the plurality of modulation control signal generation units is electrically connected to the first scan signal line to receive the first scan signal;
wherein an output terminal of the modulation control signal generation unit is electrically connected to a second modulation control signal line of the plurality of second modulation control signal lines; and
wherein the modulation control signal generation unit is configured to provide the modulation control signal to the second modulation control signal line.

10. The display panel according to claim 8, further comprising a non-display region located on at least one side of the display region, wherein the non-display region comprises a first non-display region and a second non-display region that are located on two opposite sides of the display region, respectively;
and the display panel further comprising a plurality of modulation control signal generation units, wherein an output terminal of a modulation control signal generation unit of the plurality of modulation control signal generation units is electrically connected to a second modulation control signal line of the plurality of second modulation control signal lines;
wherein the modulation control signal generation unit is configured to provide the modulation control signal to the second modulation control signal line;
wherein the plurality of shift register units are located in the first non-display region; and
wherein the plurality of modulation control signal generation units are located in the second non-display region.

11. The display panel according to claim 1, wherein
a start moment of the valid pulse of the modulation control signal is the same as a start moment of the switching stage of the first scan signal; or
a pulse width of the valid pulse of the modulation control signal is shorter than a duration of the turn-off voltage of the first scan signal.

12. The display panel according to claim 1, further comprising a plurality of light-emitting elements arranged in an array, wherein the plurality of light-emitting elements are electrically connected to the plurality of pixel driving circuits;
a pixel driving circuit of the plurality of pixel driving circuits comprises a driving transistor, a first switch transistor, and a second switch transistor, and the driving transistor and a light-emitting element of the plurality of light-emitting elements are connected in series between a first power voltage signal line of a plurality of first power voltage signal lines and a second power voltage signal line of a plurality of second power voltage signal lines;
a gate of the driving transistor is electrically connected to a first terminal of the first switch transistor, a second terminal of the first switch transistor is electrically connected to a data signal line of a plurality of data signal lines, and a gate of the first switch transistor is electrically connected to the first scan signal line;
a first terminal of the second switch transistor is electrically connected to a first terminal of the driving transistor, a second terminal of the second switch transistor is electrically connected to a reference voltage signal line of a plurality of reference voltage signal lines, and a gate of the second switch transistor is electrically connected to a second scan signal line of a plurality of second scan signal lines;
the pixel driving circuit has a light-emitting stage in which the first switch transistor and the second switch transistor are turned off; and
a pulse width of the valid pulse of the modulation control signal is shorter than a duration of the light-emitting stage.

13. The display panel according to claim 1, further comprising a display region and a non-display region located on at least one side of the display region, wherein the plurality of modulation transistors comprise a plurality of first modulation transistors, and the plurality of first modulation transistors are located within the non-display region; and
wherein a shift register unit of the plurality of shift register units is connected to a first end of the first scan signal line, and a first modulation transistor of the plurality of first modulation transistors is connected to a second end of the first scan signal line.

14. The display panel according to claim 13, further comprising a plurality of light-emitting elements arranged in an array, wherein the plurality of light-emitting elements are electrically connected to the plurality of pixel driving circuits;
a pixel driving circuit of the plurality of pixel driving circuits comprises a driving transistor and a first switch transistor, and the driving transistor and a light-emitting element of the plurality of light-emitting elements are connected in series between a first power voltage signal line of a plurality of first power voltage signal lines and a second power voltage signal line of a plurality of second power voltage signal lines;
a gate of the driving transistor is electrically connected to a first terminal of the first switch transistor, a second terminal of the first switch transistor is electrically connected to a data signal line of a plurality of data signal lines, and a gate of the first switch transistor is electrically connected to the first scan signal line; and
a channel width-to-length ratio of the first modulation transistor is greater than or equal to a channel width-to-length ratio of the first switch transistor.

15. The display panel according to claim 1, further comprising a display region,
wherein the plurality of modulation transistors comprise a plurality of second modulation transistors, and the plurality of second modulation transistors are located in the display region.

16. The display panel according to claim 15, wherein the first scan signal line is connected to one second modulation transistor of the plurality of second modulation transistors;
a shift register unit of the plurality of shift register units is connected to a first end of the first scan signal line; and
a length of the first scan signal line is L1, and a distance between the second modulation transistor and a second end of the first scan signal line is D1, wherein D1≤L1/3.

17. The display panel according to claim 15, wherein
the first scan signal line is connected to N second modulation transistors of the plurality of second modulation transistors, wherein N≥2;
a shift register unit of the plurality of shift register units is connected to a first end of the first scan signal line; and
a length of the first scan signal line is L1, and a distance between a second end of the first scan signal line and a second modulation transistor of the N second modulation transistors that is closest to the second end of the first scan signal line is D2, wherein D2≤L1/(N+1).

18. The display panel according to claim 15, further comprising a plurality of light-emitting elements arranged in an array, wherein the plurality of light-emitting elements are electrically connected to the plurality of pixel driving circuits;
a pixel driving circuit of the plurality of pixel driving circuits comprises a driving transistor and a first switch transistor, and the driving transistor and a light-emitting element of the plurality of light-emitting elements are connected in series between a first power voltage signal line of a plurality of first power voltage signal lines and a second power voltage signal line of a plurality of second power voltage signal lines;
a gate of the driving transistor is electrically connected to a first terminal of the first switch transistor, a second terminal of the first switch transistor is electrically connected to a data signal line of a plurality of data signal lines, and a gate of the first switch transistor is electrically connected to the first scan signal line; and
a channel width-to-length ratio of a second modulation transistor of the plurality of second modulation transistors is less than or equal to a channel width-to-length ratio of the first switch transistor.

19. The display panel according to claim 1, wherein the plurality of pixel driving circuits arranged in an array further comprise a plurality of pixel driving circuit rows arranged in a column direction;
a pixel driving circuit row of the plurality of pixel driving circuit rows comprises a plurality of pixel driving circuit groups arranged in a row direction;
a pixel driving circuit group of the plurality of pixel driving circuit groups comprises two adjacent pixel driving circuits along the row direction, which are referred to as a first pixel driving circuit and a second pixel driving circuit; and
in a same pixel driving circuit group of the plurality of pixel driving circuit groups, a first pixel driving circuit and a second pixel driving circuit are connected to a same data signal line of a plurality of data signal lines and to different first scan signal lines of the plurality of first scan signal lines.

20. A display device, comprising a display panel, wherein the display panel comprises:
a plurality of pixel driving circuits arranged in an array;
a plurality of first scan signal lines, wherein the plurality of first scan signal lines are electrically connected to the plurality of pixel driving circuits and are configured to provide first scan signals to the plurality of pixel driving circuits;
a plurality of shift register units, wherein the plurality of shift register units are cascaded, are correspondingly electrically connected to the plurality of first scan signal lines, and are configured to output the first scan signals to the plurality of first scan signal lines, wherein voltages of a first scan signal of the first scan signals comprise a turn-on voltage and a turn-off voltage;
a plurality of modulation transistors, wherein a first terminal of a modulation transistor of the plurality of modulation transistors is electrically connected to a first scan signal line of the plurality of first scan signal lines;
a plurality of modulation voltage signal lines, wherein a modulation voltage signal line of the plurality of modulation voltage signal lines is electrically connected to a second terminal of the modulation transistor and is configured to provide a modulation voltage to the second terminal of the modulation transistor; and
a plurality of modulation control signal lines, wherein a modulation control signal line of the plurality of modulation control signal lines is electrically connected to a gate of the modulation transistor and is configured to provide a modulation control signal to the gate of the modulation transistor, and the modulation control signal comprises a valid pulse, and the valid pulse is configured to control the modulation transistor to turn on,
wherein a switching stage between the turn-on voltage of the first scan signal and the turn-off voltage of the first scan signal overlaps the valid pulse of the modulation control signal.
